(19) United States
(12) Patent Application Publication
(10) Pub. No.: US 2025/0164401 A1
(43) Pub. Date: May 22, 2025

(54) Systems and Methods for Multiphoton Microscopy

(71) Applicant: The Board of Trustees of the University of Illinois, Urbana, IL (US)

(72) Inventors: Haohua Tu, Savoy, IL (US); Geng Wang, Urbana, IL (US)

(21) Appl. No.: 18/951,170

(22) Filed: Nov. 18, 2024

Related U.S. Application Data
(60) Provisional application No. 63/600,512, filed on Nov. 17, 2023.

(51) Int. Cl. G01N 21/64

(52) U.S. Cl. CPC G01N 21/6486

(57) ABSTRACT

Multiphoton microscopy provides a non-invasive tool capable of monitoring metabolic states and/or the overall health of live cells with improved spatial resolution. A laser light source (e.g., a femtosecond laser) is used to excite one or more fluorophores, harmonophores, or other molecules in a biological sample and photonics are used to image, monitor, and retain cell health. Phototoxicity is reduced by rapidly scanning a laser light source over the sample such that full triplet relaxation in the sample is obtained, thereby reducing phototoxicity.

### CROSS-REFERENCE TO RELATED APPLICATIONS

This application claims priority to and the benefit of U.S. Provisional Application No. 63/600,512, filed Nov. 17, 2023 and titled “Systems and Methods for Reduced Phototoxicity in Multiphoton Microscopy,” the entire contents of which are herein incorporated by reference in their entirety for all purposes.

### STATEMENT REGARDING FEDERALLY SPONSORED RESEARCH OR DEVELOPMENT

This invention was made with government support under CA241618 awarded by the National Institutes of Health. The government has certain rights in the invention.

### TECHNICAL FIELD

This disclosure relates to the field of microscopy. More particularly, this disclosure relates to systems and methods for multiphoton microscopy with reduced phototoxicity.

### BACKGROUND

In multiphoton microscopy (“MPM”), near-infrared (“NIR”) femtosecond lasers use multiple excitation photons (e.g., two or more photons) for imaging. MPM has applications for imaging living biological tissues and/or cells. The use of NIR femtosecond lasers allows for improved depth penetration while reducing photodamage to the tissues being imaged. In this way, MPM is able to achieve dynamic imaging of features deep within living organisms, and other highly scattered materials. As non-limiting examples, MPM has been used to examine membrane potentials, embryo development, and calcium transport in mice.

Confocal and deconvolution microscopy, fluorescent microscopy, phase contrast microscopy, and quantitative phase contrast are other imaging modalities that have been used to image live biological tissues and/or cells. These imaging techniques are limited, however, in that they can require harsh lighting and/or toxic dyes, and because they are unable to image deeper, scattered tissues.

MPM according to comparative examples has technical drawbacks that can limit its widespread use. As one example, photobleaching and photodamage can occur, which can lead to protein denaturation, DNA damage, and/or oxidative stress. As another example, the pulse duration and power used in MPM can be a limitation, especially with two-photon excitation fluorescence generation. For instance, the rate of cell damage increases as the pulse width becomes smaller and/or as the average power increases. As still another example, three-photon excitation uses high peak powers, which can run the risk of causing cell and/or DNA damage.

### SUMMARY

The present disclosure addresses the aforementioned and other drawbacks by providing systems and methods for multiphoton microscopy. The systems and methods described herein provide several advantages over the comparative examples, including but not limited to reduced phototoxicity

According to one example of the present disclosure, a method for multiphoton microscopy is provide. The method comprises exciting a biological sample using a light source that is rapidly scanned over the biological sample to increase triplet relaxation in the biological sample; simultaneously detecting light emitted by molecules in the biological sample in a plurality of colors; and creating an image or a temporal series of images from the light detected in the plurality of colors.

### BRIEF DESCRIPTION OF THE DRAWINGS

Features, objects, and advantages of the present technology will become more readily apparent when consideration is given to the detailed description below. Such detailed description makes reference to the following drawings, wherein:

FIG. 1 illustrates example phototoxicity mechanisms according to various aspects of the present disclosure.

FIG. 2A illustrates example images collected using time-lapse imaging according to various aspects of the present disclosure.

FIG. 2B illustrates example integrated signals for the example images of FIG. 2A.

FIG. 3 illustrates example fluorescence characteristics according to various aspects of the present disclosure.

FIG. 4A illustrates example phototoxicity characteristics according to various aspects of the present disclosure.

FIG. 4B illustrates example phototoxicity characteristics according to various aspects of the present disclosure.

FIG. 4C illustrates example phototoxicity characteristics according to various aspects of the present disclosure.

FIG. 5 illustrates example growth rate characteristics according to various aspects of the present disclosure.

FIG. 6 illustrates example growth rate characteristics according to various aspects of the present disclosure.

FIG. 7 illustrates example growth rate characteristics according to various aspects of the present disclosure.

FIG. 8 illustrates example bubble formation characteristics according to various aspects of the present disclosure.

FIG. 9A illustrates example fluorescence lifetime imaging characteristics according to various aspects of the present disclosure.

FIG. 9B illustrates example fluorescence lifetime imaging characteristics according to various aspects of the present disclosure.

FIG. 10 illustrates example images according to various aspects of the present disclosure.

FIG. 11 illustrates an example imaging system that can implement a photon order expanded multiplexing technique according to various aspects of the present disclosure.

FIG. 12 illustrates an example laser scanning microscope configured for multiphoton microscopy, which can be used as a detection system in the imaging system of FIG. 11 in various aspects of the present disclosure.

FIG. 13 illustrates an example method for multiphoton microscopy to simultaneously acquire optical signal data from multiple imaging modalities, contrasts, or processes (e.g., multiple different photon order processes) while monitoring and minimizing phototoxicity in the biological sample.

FIG. 14 illustrates example images simultaneously acquired from a biological sample using a 2PAF process, a 3PAF process, a 4PAF process, and a THG process.

FIG. 15 illustrates example images simultaneously acquired from a biological sample using a 2PAF process, a 3PAF process, a 4PAF process, a 2 PF process, an SHG process, and a THG process.

### DETAILED DESCRIPTION

The present technology will now be described more fully with reference to the accompanying drawings, in which some, but not all, embodiments are shown. Indeed, the technology may be embodied in many different forms and should not be construed as limited to the embodiments set forth herein; rather, these embodiments are provided so that this disclosure will satisfy applicable legal requirements.

Likewise, many modifications and other embodiments of the technology described herein will come to mind to one of skill in the art to which the invention pertains having the benefit of the teachings presented in the following descriptions and the associated drawings. Therefore, it is to be understood that the disclosure is not to be limited to the specific embodiments disclosed and that modifications and other embodiments are intended to be included within the scope of the disclosure. Although specific terms are employed herein, they are used in a generic and descriptive sense only and not for purposes of limitation. Unless defined otherwise, all technical and scientific terms used herein have the same meaning as commonly understood by one of skill in the art to which the technology pertains.

Throughout the specification and claims, terms may have meanings suggested or implied in context beyond an explicitly stated meaning. Likewise, the phrases “in one embodiment,” “in one example, “in one aspect,” or “in one implementation” as used herein do not necessarily refer to the same embodiment, example, aspect, or implementation; and the phrases “in another embodiment,” “in another example,” “in another aspect,” or “in another implementation” as used herein do not necessarily refer to a different embodiment, example, aspect, or implementation. It is intended, for example, that the claimed subject matter includes combinations of exemplary embodiments, examples, aspects, or implementations in whole or in part.

In general, terminology may be understood at least in part from usage in context. For example, terms such as “and,” “or,” or “and/or” as used herein may include a variety of meanings that may depend at least in part upon the context in which such terms are used. For example, the use of “or” to associate a list, such as “A, B, or C” is intended to mean “A, B, and C,” here used in the inclusive sense, as well as “A, B, or C,” here used in the exclusive sense. IN addition, the phrase “one or more” or “at least one” as used herein, depending at least in part upon context, may be used to describe any feature, structure, or characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” or “determined by” may be understood as not necessarily intended to convey an exclusive set of factors and may, instead, allow for the existence of additional factors not necessarily expressly described, again, depending at least in part on context. Unless defined otherwise, all technical and scientific terms used herein have the same meaning as commonly understood by one of skill in the art to which the invention pertains.

The present disclosure provides for systems, devices, and methods for multiphoton microscopy and/or imaging, which provide a non-invasive tool capable of monitoring metabolic states and/or the overall health of live cells with improved spatial resolution as compared to other available imaging techniques. In general, the imaging system includes a laser light source (e.g., a femtosecond laser) and uses photonics to image, monitor, and retain cell health. The noninvasive laser light source uses, as a non-limiting example, label-free multiphoton microscopy to monitor and image live cells and/or tissues without introducing significant phototoxicity. For instance, intracellular molecular metabolites (e.g., FAD, NAD (P)H, tryptophan) and other molecular compounds in live cells and tissues can be imaged in real-time without inducing phototoxicity. Phototoxicity can be monitored by blue hyperfluorescence, as an example. Advantageously, the disclosed systems and methods can be applied to harmonic microscopy, fluorescence, optical coherence tomography, confocal reflectance microscopy, and flow cytometry, among others.

Nonlinear optical (multi-photon) microscopy is a technique that enables deep tissue optical sectioning of endogenous fluorophores and harmonophores, through an order n>1 process. This enables imaging of molecular, cellular, structural, and specific markers that highlight different parts of a biological tissue and their dynamic activity. Given all the aforementioned properties, nonlinear optical microscopy has become a tool used in many research institutes and industry as well. An example of this technique is the simultaneous label-free autofluorescence-multiharmonic (SLAM) microscopy method, which is comprised of 2- and 3-photon autofluorescence (2PAF and 3PAF), and second and third harmonic generation (SHG and THG) microscopy modalities. The former two can identify and measure metabolic signatures such as FAD and NAD (P)H molecules, and the latter two can image structural conformation of a tissue such as collagenous structures and refractive index inhomogeneity.

The disclosed systems and methods provide for a live-cell assay that uses photon order expanded multiplexing (“λPOEM”) to image biological tissues and/or cells. Further, it is an advantage of λPOEM that four or more general contrasts of live cells can be simultaneously acquired. To achieve this technical effect, the disclosed systems and methods accompany the shift of the excitation wavelength with laser source engineering of excitation pulses (e.g., repetition rate, pulse duration, incident average power, and scanned illumination) to provide balanced generation of multicolor signals. As a non-limiting example, λPOEM can be used to image intracellular molecular metabolites, such as FAD, NAD (P)H, tryptophan, and so on. For instance, FAD sensing can be achieved using λPOEM to provide 2-photon excited autofluorescence, NAD (P)H sensing can be achieved using λPOEM to provide 3-photon excited autofluorescence, and tryptophan sensing can be achieved using λPOEM to provide 4-photon excited autofluorescence. Advantageously, λPOEM enables a live-cell assay to simultaneously image these intracellular molecular metabolites via 2-, 3-, and 4-photon excited auto-fluorescence (i.e., 2PAF, 3PAF, and 4PAF) intensity (and lifetime), respectively, using a single laser pulse train with an engineered repetition rate (e.g., ˜5 MHz), pulse width (e.g., ˜60 fs FWHM), and spectral band centered at approximately 1110 nm.

For a fixed long-wavelength (>1000-nm) excitation, there remains a need for simultaneous multicolor sensing of biological cells to collect at least two distinct (e.g., independent or orthogonal) contrasts. Advantageously, the systems and methods described in the present disclosure enable simultaneous multicolor sensing to collect two or more contrast, such as those selected from the group including FAD (e.g., via 2PAF), NADH or NAD (P)H (e.g., via 3PAF), nonlinear optical heterogeneity (e.g., via THG), and tryptophan (e.g., via 4PAF).

By focusing the laser illumination to a diffraction-limited point in the sample and scanning the point at a moderately fast speed (e.g., ˜1.5 m/s) to acquire one image pixel per pulse, cell health can be monitored and retained during prolonged time-lapse imaging via a real-time inline phototoxicity indicator of increasing autofluorescence (e.g., blue hyperfluorescence), without resorting to a time-consuming offline biological phototoxicity assay. The cells can also be simultaneously imaged by second- and third-harmonic generation microscopy (i.e., SHG and THG) to gain non-fluorescent intrinsic contrasts from the same laser pulse.

With little to no modification to the microscope or other detection system, the methods described in the present disclosure can be readily adapted from imaging live cells to live tissues, and from label-free imaging to specifically labeled imaging of infrared fluorophores (e.g., via 2 PF. The 2-photon signals (2 PF, 2PAF, and SHG), 3-photon signals (3PAF and THG), and 4-photon signal (4PAF) are spectrally separated with little to no interference, and thus provide independent and comprehensive molecular information for a given sample and/or specimen. Additional inclusion of 1-photon signals via optical coherence tomography and/or confocal reflectance microscopy in the detection system can be readily implemented as well, and would advantageously allow for simultaneous acquisition of diverse signals with a photon order from 1 to 4.

A flow cytometry counterpart of λPOEM microscopy can also be implemented by removing the scanner of the microscopy and defocusing the illumination. An attractive form of imaging flow cytometry can also be implemented to intermediate between λPOEM microscopy and flow cytometry.

### Experimental Discussion

Sample health is important for live-cell fluorescence microscopy and has promoted light-sheet microscopy that restricts its ultraviolet-visible excitation to one plane inside a three-dimensional sample. Comparative examples of laser-scanning nonlinear optical microscopy, which similarly restrict its near-infrared excitation, has not broadly enabled gentle label-free molecular imaging. In support of the systems and method set forth herein, it was first hypothesized that intense near-infrared excitation induces phototoxicity via linear absorption of intrinsic biomolecules with subsequent triplet buildup, rather than the commonly assumed mechanism of nonlinear absorption. Using a reproducible phototoxicity assay based on the time-lapse elevation of auto-fluorescence (hyper-fluorescence) from a homogeneous tissue model (chicken breast), experimentation was performed to provide strong evidence supporting this hypothesis. The study justifies an imaging technique, e.g., rapidly scanned sub-80-fs excitation with full triplet-relaxation, to mitigate this ubiquitous linear-absorption-mediated phototoxicity independent of sample types. The corresponding label-free imaging can track freely moving C. elegans in real-time at an irradiance up to one-half of water optical breakdown.

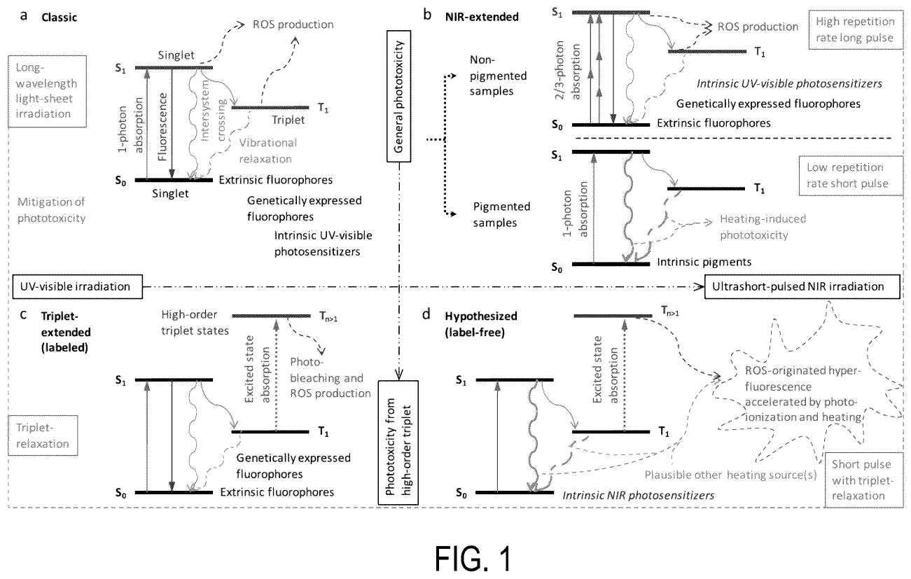

Due to plausible artifacts from light itself, live-cell fluorescence imaging has increasingly emphasized sample health over metrics such as signal-to-noise ratio (SNR) and spatiotemporal resolution. FIG. 1 illustrates various mechanisms of phototoxicity using Jablonski diagrams. In particular, diagram (a) is the classic mechanism with UV-visible excitation, diagram (b) is a NIR-extended mechanism with scanning ultrashort-pulsed NIR excitation at the focus of a microscope objective, diagram (c) is a triplet-extended mechanism with UV-visible excitation of labeling fluorophores, and diagram (d) is a hypothesized mechanism at the phototoxicity threshold with the same NIR excitation but without the labeling. One-photon absorption of certain chromophore(s) followed by efficient inter-crossing to a first-order triplet state results in high-order triplet-induced heating-accelerated white hyper-fluorescence (WHF).

The classic mechanism of phototoxicity, as illustrated in diagram (a) of FIG. 1, attributes the toxicity to the excited singlet and triplet states of extrinsic (labeling) UV-visible-absorbing fluorophores that induce reactive oxygen species (ROS). Thus, wide-field planar excitation that restricts the excitation to a focal plane (e.g., light-sheet microscopy) has been used to avoid out-of-focus ROS production in comparative wide-field or laser-scanning fluorescence microscopy. Another comparative technique is to excite the labeling fluorophores at the long-wavelength end of UV-visible excitation (300-650 nm), which mitigates the phototoxicity from intrinsic ROS-generating photosensitizers but limits the choices to fluorescently label the sample. By avoiding this limitation from other examples of continuous-wavelength excitation, near-infrared (NIR) extension (700-1300 nm) with laser-scanning ultrashort (<10 ps) pulses has recovered the planar excitation and efficiently excited the extrinsic fluorophores via nonlinear absorption. This is illustrated in diagram (b) of FIG. 1.

However, raster scanned ultrashort-pulsed NIR excitation at the focus of a high numerical aperture (NA) microscope objective has either facilitated linear-absorption-mediated heating toxicity in pigmented samples, which should be mitigated by low repetition rate short pulse, or commonly assumed nonlinear-absorption-mediated phototoxicity in non-pigmented samples, which should be mitigated by high repetition rate long pulse. Because the two are differentiated rather arbitrarily based on often unavailable NIR absorption property of the sample, no universal technique exists for both cases. Also, the related NIR-extended mechanism favors a light-dose (fluence) threshold for phototoxicity over an irradiance threshold (typically proportional to average power or pulse energy), which is inconsistent with empirical experiences. These apparent contradictions are illustrated in Table 1. Moreover, this mechanism offers no satisfactory explanation on why the phototoxicity decreases with increased speed of fast-axis scanning, even though other parameters are comparable. The relationship between phototoxicity and speed is illustrated in Table 2. In table 2, differences in parameters other than fast-axis scanning speed under typical high NA (˜1) focusing are ignored. “CARS” imaging refers to coherent anti-Stokes Raman scattering microscopy.

TABLE 1
Apparent contradictions in gentle laser-scanning nonlinear optical imaging

| | | Contradictory | Observation/view from |
|---|---|---|---|
| | Popular observation/view | observation/view | this study |
| Phototoxicity | Absence of a threshold power | Existence of this threshold | Unambiguous existence of |
| threshold | or pulse energy (irradiance) | below which phototoxicity | an irradiance threshold |
| | because phototoxicity | does not depend on fluence | under one pulse per |
| | depends on fluence or dose | or dose | diffraction-limited- |
| | | | resolution imaging |
| Repetition rate | GHz beneficial and external | Down to 1-MHz beneficial | 5-20 MHz beneficial |
| (for two-photon | pulse splitter are favorable | (even for non-pigmented | depending on imaging |
| imaging) | | samples at shallow imaging | speed-depth tradeoff |
| | | depths) | |
| Pulse duration | Irrelevant across a wide | Short (<100 fs) pulses | Short (<100 fs) pulses |
| | regime (75 fs to 3.2 ps) | beneficial (even for non- | beneficial due to |
| | | pigmented samples) | hypothesized mechanism |
| Single-pulse | Irrelevant due to low linear | Relevant (even for non- | Relevant due to accelerated |
| heating | absorption of water in non- | pigmented samples) from | phototoxicity at low |
| | pigmented samples and | imaging to surgery | irradiance (phototoxicity) |
| | highly nonlinear | | |
| | phototoxicity | | |
| Photo-damage | Detectable likely due to | Not detectable as phototoxic | Not likely at the threshold |
| to nucleus | ROS-related toxicity with | hyper-fluorescence is | of heating-accelerated |
| | strong hyper-fluorescence | limited to cytoplasm | phototoxicity |

TABLE 2
Dependence of NIR phototoxicity on fast-axis scanning speed or pulses per
diffraction-limited-resolution (PPD) of ~80 MHz pulses

| | Slow scanning with high phototoxicity at | Fast scanning with low phototoxicity at |
|---|---|---|
| | low irradiance/power/pulse-energy | high irradiance/power/pulse energy |
| Cell viability | Cell death and detectable WHF at ~2 | No cell death (viability assessed by DNA |
| and WHF | μm/ms or ~1.5 × 10⁴ PPD (730-nm, | synthesis) and no detectable WHF at ~35 |
| assays | 150-fs, 80-MHz, 6 mW), and ~5 μm/ms | μm/ms or ~860 PPD (740-nm, 75-fs, 81- |
| | or ~6.2 × 10³ PPD (780-nm, 170-fs, | MHz, 17 mW) |
| | 80-MHz, 7.3 mW) | |
| Cell ROS assay | ROS production in cultured cells at ~5 | No ROS production in developing |
| | μm/ms or ~6.4 × 10³ PPD (800-nm, | embryos at ~60 μm/ms or ~690 PPD |
| | 170-fs, 80-MHz, 7 mW | (1047-nm, 175-fs, 120-MHz, 13-20 mW) |
| Laser surgery | Laser surgery at ~2 μm/ms or | Gentle imaging at ~2.2 × 10⁴ μm/ms or ~1.4 |
| (with WHF) vs. | ~1.5 × 10⁴ PPD (800-nm, ~100-fs, | PPD (800-nm, ~120-fs, 80-MHz, 200 mW |
| gentle imaging | 76-MHz, 60 mW | at 250-μm imaging depth), ~2.3 × 10³ |
| | | μm/ms or ~14 PPD (720-950-nm, ~100-fs, |
| | | 80-MHz, 40 mW), and 150 μm/ms or 315 |
| | | PPD (1180-nm, 100-fs, 80-MHz, 120 mW) |
| Long-term brain | Impossible at <100 μm/ms or >320 PPD | Possible at ~2.2 × 10³ μm/ms or ~14 PPD |
| calciμm imaging | (800-nm, 140-fs, 80-MHz, 18-48 mW) | (800-nm, 120-fs, 80-MHz, 18 mW |
| Cell functional | Functional change at ~24 μm/ms or | No functional change at ~2.2 × 10³ μm/ms |
| assays | ~1.5 × 10³ PPD (920-nm, ~100-fs or | or ~14 PPD (775-nm, 100-ps, 80-MHz, |
| | cw, ~80-MHz, 17 mW at 78-μm | 140 mW) |
| | imaging depth) | |
| CARS imaging | Phototoxicity thresholds at ~50 μm/ms | No observable phototoxicity at ~2 × 10³ |
| | or ~650 PPD (711/892 nm, 2-ps, | μm/ms or ~17 PPD (780-930/1064 nm, |
| | 9 mW at 82-MHz) | ~6-ps, 76-MHz, 100 mW) |

The present disclosure aims to overcome these deficiencies in knowledge based on another extension of the classic mechanism, i.e., triplet-extended mechanism of photobleaching-related phototoxicity from the labeling agents of extrinsic fluorophores and genetically expressed fluorophores. This is illustrated in diagram (c) of FIG. 1. This mechanism offers a satisfactory explanation (i.e., triplet-relaxation) on why a fast-scanning speed effectively mitigates the phototoxicity in both confocal fluorescence microscopy and stimulated emission depletion microscopy. Specifically, high-order triplet states produced by excited state absorption, rather than first-order triplet/singlet states and high-order singlet states, dominate the observed UV-visible phototoxicity from bioassays. Considering the similar dependence of the NIR phototoxicity on the scanning speed (see Table 2), it is hypothesized that the corresponding NIR extension would follow a similar mechanism in label-free (clinically permissible) nonlinear optical imaging, as illustrated in diagram (d) of FIG. 1. The focus on the label-free scenario in this study will ultimately guide more complicated scenarios with diverse labeling fluorophores.

The hypothesized mechanism asserts that linear absorption of intrinsic NIR photosensitizers mediates the NIR phototoxicity in unlabeled samples, rather than the commonly assumed nonlinear absorption of intrinsic UV-visible photosensitizers such as NAD (P)H, flavins, and porphyrins. This is plausible because in a broad (non-imaging) context, the existence of intrinsic NIR photosensitizers has been demonstrated in E. coli inside an optical trap and cultured cells under phototherapy capable of ROS production. Another unusual feature is the enhancement of high-order triplet-mediated ROS production by linear absorption-induced heating like that in pigmented samples such as skin and retina. This is inspired by the heating-accelerated phototoxicity in excessive photobiomodulation, and as shown below, can reconcile various contradictory views on the NIR phototoxicity (see Table 1). All evidence that favor the nonlinear-absorption-mediated phototoxicity in unlabeled samples can be alternatively interpreted by the hypothesized mechanism to reconcile with those that favor the linear-absorption-mediated phototoxicity in non-pigmented samples. Tables 3-5 illustrate this interpretation and associated observations. It should be noted that the effects described in Table 4 have been observed by different research groups in diverse cells, extracellular matrices, and tissue types, independent of laser pulse widths (fs-ns), excitation wavelengths (throughout NIR), and imaging acquisition parameters.

TABLE 3
Reinterpretation of observed nonlinear NIR phototoxicity in
unlabeled non-pigmented samples.

| | | Reinterpretation to reconcile with |
|---|---|---|
| | Evidence supporting multiphoton- | linear-absorption-mediated |
| | absorption-mediated phototoxicity | nonlinear phototoxicity |
| Power laws in cell | Power- and/or pulse-duration-dependent | Acceleration by photoionization and |
| assays (0.7-1.0 | phototoxic assays attain an apparent | heating of an otherwise linear |
| μm excitation) | multi-photon (≥2) order | phototoxicity attains apparently |
| | | nonlinear phototoxicity |
| Pulsed versus cw | Absence of phototoxicity when pulsed | Unlike linear phototoxicity, linear- |
| phototoxicity | exaction is switched to cw excitation | absorption-mediated nonlinear |
| | (with larger powers) | phototoxicity accelerates with |
| | | increasing power |
| Linked auto- | Coincidence of photon order in | Acceleration by photoionization- |
| fluorescence | bleaching and lesion generation (~4) | heating and poor indication of |
| bleaching and | suggests NADH as a photosensitizer | phototoxicity by photo-bleaching |
| lesion | | result in this effect |
| Cellular ROS | Similarity to UV-visible-induced ROS | Single-photon excitation of NIR |
| production and | and metabolic change suggests | intrinsic photosensitizers with efficient |
| metabolic change | multiphoton (rather than single-photon) | intersystem crossing to triplet state |
| (0.7-1.0 μm | excitation of intrinsic UV-visible | induces this ROS production and |
| excitation) | sensitizers | metabolic change alternatively |
| Confined photo- | More phototoxicity from single-plane | Linear-absorption-mediated nonlinear |
| toxicity in one | illumination over multiplane | phototoxicity attain an apparent |
| illumination plane | illumination of developing embryos | nonlinearity to confine phototoxicity |
| (1.0-1.2 μm | suggests a multiphoton origin | in one illumination plane |
| excitation) | | |
| Water absorption | Low and wavelength-dependent water | Exclusion of heating via water as the |
| in a high | absorption prohibits related heating as | primary source for phototoxicity does |
| NA microscope | source for phototoxicity | not rule out linear phototoxicity from |
| objective | | a non-water NIR photosensitizer |
| | | in the hypothesized mechanism |
| Nonlinear | Fluorescence bleaching attain a >2 | Photo-bleaching of intrinsic and |
| fluorescence | photon order (higher than that of | extrinsic fluorophores is a poor |
| photo-bleaching | “photo-enhancement”) | indicator of phototoxicity |

TABLE 4
Hyper-fluorescence-like effects observed with diverse multiphoton illuminations in
unlabeled non-pigmented live specimens

| | | Fast-axis scanning | |
|---|---|---|---|
| Terminology | Live specimen of | speed on sample (and | |
| (photon order) | model system | other parameters) | Observation and description |
| Broadband | Myelin sheath in | 0 μm/ms for 22-25 s | Photodamage of CARS imaging in |
| luminescence (1.1) | spinal tissues from | (704 and 880 nm, 2.5- | point scan mode yields a photon |
| | guinea pig | ps, 3.9-MHz, ~2.4 mW, | order of 1.1-1.8, which increases with |
| | | 60×/1.2-NA) | incident power |
| Photoenhancement | Rabbit red | ~4 μm/ms (810-nm, 14 | Photoenhancement occurs less |
| (1-2) | blood cells | fs (2.2 mW) or 280 fs | readily with shorter pulses. The |
| | | (7.3 mW), 86-MHz, | overall fluorescence increase is over |
| | | 40×/1.1-NA) | 15-fold |
| Fluorescent scar | Diverse cells and | ~2 μm/ms (800-nm, | Wounds as small as 1 μm in diameter |
| (2.5) | tissue types | ~100-fs, 76-MHz, 60 | 20 μm from the surface are made by |
| | | mW, 25×/0.8-NA) | multiphoton excitation with |
| | | | characteristic fluorescent scar |
| Hyper-fluorescence | Mouse gut | ~8 μm/ms (800-nm, | Narrow bandwidth laser is preferable |
| (>2) | mucosa | 10/220 fs, 85/80 MHz, | to ultrabroadband excitation for |
| | | 40x/1.2-NA) | autofluorescence-2-photon |
| | | | microscopy |
| Intrinsic indicator | Diverse cells and | 50 μm/ms (781-nm, 1.2 | Photodamage indicator independent |
| (3.17) | tissues | ps, 80-MHz, 27-52 mW, | of in vivo or ex vivo tissue state; |
| | | 32×/0.85-NA) | photon order 3.17 for ex vivo brain |
| | | | cryosections |
| Fluorescent lesion | Rat basophilic | ~9 μm/ms (740-nm, | The frequency of fluorescent lesion |
| (4.28) | leukemia cells | 145-fs, 80-MHz, 5-25 | formation increases approximately as |
| | | mW, 1.3-NA) | the fourth power of the laser intensity |
| Photo-modulation | Purified collagen | ~5 μm/ms (780-nm, | Increased two-photon auto- |
| (6) | samples | 120-fs, 80-MHz, 6-60 | fluorescence and decreased second |
| | | mW, 20x/NA 0.5 or | harmonic generation similar to 60° C. |
| | | 40x/1.3-NA) | denaturation |

TABLE 5
Quantitative phototoxicity bioassays with multiphoton excitation

| Nature of | | Fast-axis scanning speed | |
|---|---|---|---|
| bioassay | Live specimen of | on sample (and other | |
| (photon order) | model system | parameters) | Details of bioassay |
| Inline labeled | Cortical astrocytes | ~24 μm/ms (920-nm, | Calciμm microdomain |
| (1) | in mouse brain | ~100-fs or cw, ~80-MHz, | hyperactivity |
| | slices | 17 mW, 20×/0.95-NA) | |
| Offline labeled | Drosophila | 0 μm/ms (800-nm, 37/100- | TUNEL cell assay in |
| (1.19-1.28) | melanogaster | fs, 1-kHz, irradiance 0.1 | salivary glands superficially |
| | | TW/cm², no focusing) | located in the larva's body |
| Inline labeled | Neocortical | ~2 μm/ms (870-nm, 75-fs | Basal fluorescence of |
| (2) | neurons in rat | with 3-7 mW or 3.2-ps | various Ca²⁺-indicators |
| | brain slices | with 8-24 mW, ~80-MHZ, | |
| | | 60×/0.91-NA) | |
| Offline label- | Chinese hamster | ~5 μm/ms (780-nm, 170-fs, | Reduced cloning efficiency |
| free (2) | ovary cells | 80-MHz, 7.3 mW, 40×/ | (clone consists of <8 cells) |
| | | 1.3-NA) | |
| Inline labeled | Bovine adrenal | 25 μm/ms (840-nm, 190-fs, | Changes in resting [Ca2+] |
| and offline | chromaffin cells | 82-MHz, 7-20 mW, | level via FURA-2 and |
| label-free (2.5) | | 63×/0.9-NA) | degranulation reaction |
| Offline label- | Drosophila | 150 μm/ms (1180-nm, 100- | Embryo survival rate and |
| free (2-3) | embryos | fs, 80-MHz, 120 mW, | cellularization speed |
| | | 20x/0.95-NA) | |
| Offline labeled | Chinese hamster | 8-20 μm/ms (695-810 nm, | Damage to nucleus like that |
| (2-3) | ovary cells | 130-fs, 80-MHz, 14 mW | from exposure to solar |
| | | typically, 40x/0.8-NA) | ultraviolet light |

The experiments discussed herein are motivated by the intrinsic indicator of phototoxicity specific to nonlinear optical microscopy, i.e., elevated auto-fluorescence during time-lapse imaging of diverse (live) cell/tissue specimens. This effect has been observed by different groups with widely varied excitation-scanning parameters and samples, resulting in different terminologies such as “white flashes,” “flickering/broadband luminescence,” “fluorescent scar/lesion,” “photo-modulation,” “photo-enhancement,” and “hyper-fluorescence” (see Table 4). Despite the established functional link to impaired cell cloning and ROS/apoptosis, these different terminologies may have hindered a general understanding of the same underlying phenomenon not observable by linear optical microscopy. The term “white hyper-fluorescence” (WHF) is adopted throughout the present disclosure to emphasize its broadband emission and inline (built-in) indication of phototoxicity in unlabeled biological samples.

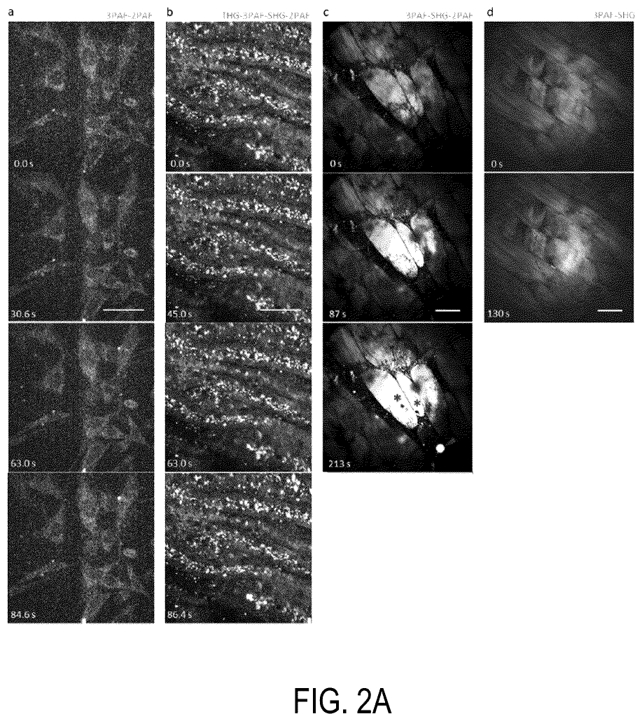

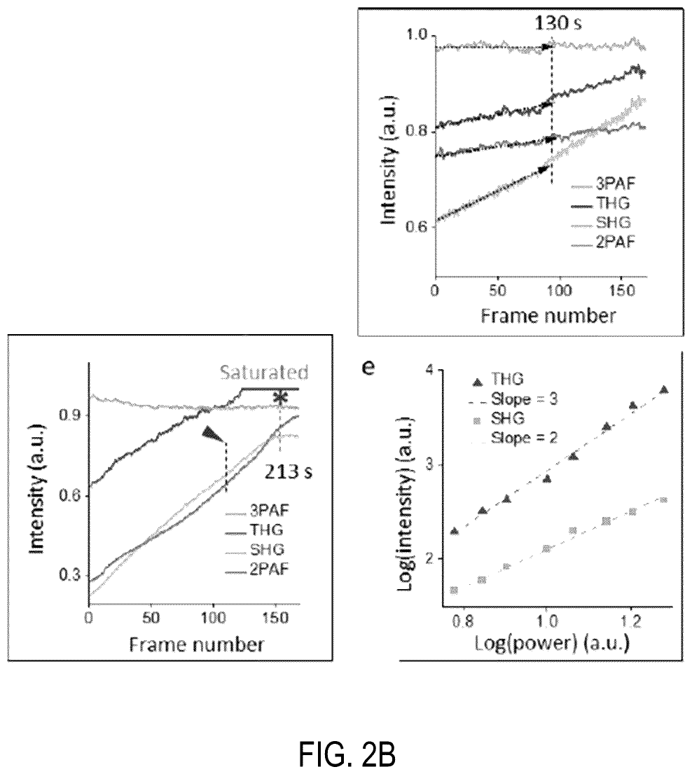

The experiments described herein employed various simultaneous label-free autofluorescence-multiharmonic (SLAM) microscopy in time-lapse imaging of live cell and ex vivo mouse kidney tissue, with four simultaneously acquired molecular contrasts of two-/three-photon auto-fluorescence (2PAF/3PAF) and second-/third-harmonic generation (SHG/THG). A portable SLAM microscope (pSLAM) with more flexible excitation-scanning parameters and an extended version of SLAM microscope (eSLAM) with a faster imaging speed were built. FIG. 2A illustrates the observed phototoxicity. Column (a) shows cultured hamster kidney cells imaged by eSLAM at a frame rate of 0.56 Hz, and show heterogenous “white” WHF due to simultaneous increase of 3PAF/cyan and 2PAF/yellow signals (arrowheads). Column (b) shows ex vivo mouse kidney tissue imaged by eSLAM at a frame rate of 0.56 Hz, showing similar WHF (arrowheads). The images in column (c) are of chicken breast imaged by pSLAM (25 mW, spatiotemporal bin-10) at a frame rate of 0.7 Hz, and show emergence of homogenous WHF (broken circle) followed by heterogenous WHF (arrowheads) and subsequent bubble formation (stars). Column (d) shows chicken breast imaged by pSLAM at a lower power (15 mW, spatiotemporal bin-10), and show only the homogenous WHF (broken circle). The scale bar represents 50 μm. In FIG. 2B, the bottom-left graph shows integrated signals over one frame versus frame number during time-lapse imaging, the top-right graph shows the integrated signals with linear growth (arrowed lien), and the bottom-right graph shows integrated THG/SHG signals versus power (baseline illumination) in different FOVs that follow power-3/power-2 law according to the photon order of nonlinear optical processes.

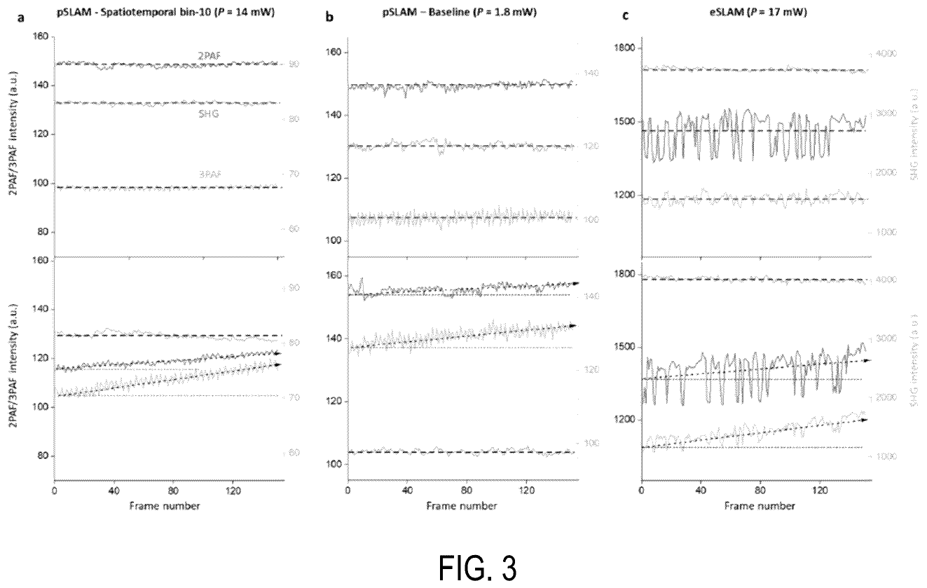

The point-spreading heterogeneous WHF detected by eSLAM across 2PAF-3PAF detection spectrum of 420-640 nm (see Table 6) was not amenable for quantification. In contrast, under an illumination of pSLAM (spatiotemporal bin-10, see Table 7) except for a higher average power, the emergence of homogeneous WHF in chicken breast tissue was observed across a large area of field-of-view (FOV) before the occurrence of similar heterogeneous WHF and subsequent bubble formation. In Table 7, all images were captured with an imaging depth of ˜10 μm, a frame of 1024 pixels×1024 pixels, and an FOV of 300 μm×300 μm. Lowering the power avoided the heterogeneous WHF in time-lapse imaging, during which the homogeneous WHF underwent linear growth initially rather than a decrease via photo-bleaching, until a power threshold at WHF onset was reached (14 mW in graph (a) of FIG. 3). The homogeneous WHF attains a spatial distribution that approximates the illumination field measured in a fluorophore solution, indicating the field strength-dependent phototoxicity. The increased THG signal most likely arises from the blue edge of WHF, while the corresponding increase in SHG signal may be canceled by a decrease due to thermal denaturing (see FIG. 2B).

TABLE 6
Comparison of heterogenous and homogenous WHF in SLAM-based imaging

| | Heterogenous WHF | Homogenous WHF |
|---|---|---|
| Prevalence | Inevitably present in cell culture and | Observable in ex vivo chicken breast and |
| | live tissue at sufficiently high | mouse brain but not cell culture and ex |
| | power/irradiance or dosage | vivo mouse kidney |
| Initial photo- | Random point(s) within the field-of- | Center of field-of-view with the highest |
| damage site | view | irradiance |
| Time-lapse | Increase of both intensity and spatial | Uniform elevation across a large area of |
| morphology | scope in a point-spreading fashion | illμmination field |
| Nature of | Dependent on light dosage like bubble | Dependent on threshold power/irradiance |
| phototoxicity | formation by ultrashort pulses | unlike the bubble formation by ultrashort |
| | | pulses |
| Time-lapse | Not observable in the first frame but | Observable in the first frame with linear |
| phototoxicity | with nonlinear increase over | increase over frame/time |
| | frame/time | |
| Stage of | Late stage after onset of homogeneous | Early stage during photobleaching-to- |
| phototoxicity | WHF (chicken breast as example) | WHF transition (chicken breast and |
| | | mouse brain as examples) |
| Lifetime | Short (~0.6 ns) | Long (>1 ns) |
| Quantitative | Unsuitable due to random and point- | Suitable due to homogeneous |
| analysis and | spreading morphology, dependence on | morphology, dependence on threshold |
| modeling of | light dosage, and nonlinear increase at | power/irradiance, and linear increase at |
| phototoxicity | a late stage of phototoxicity | an early stage of phototoxicity |

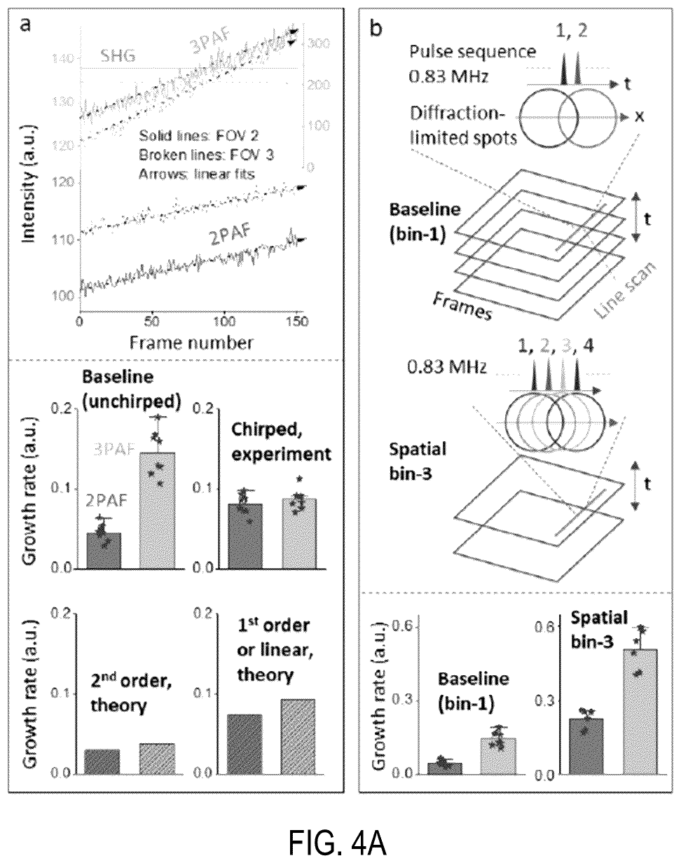

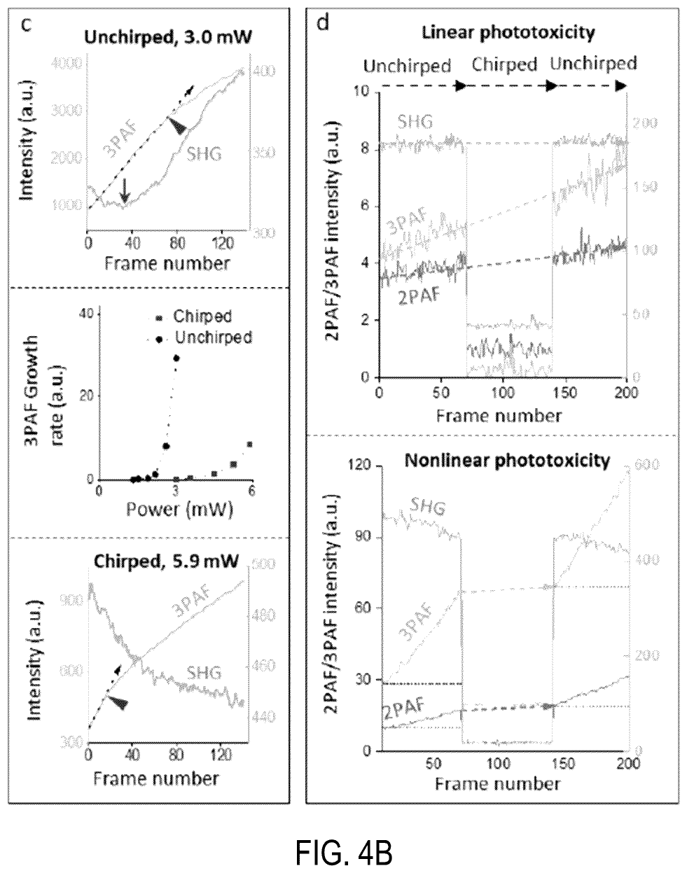

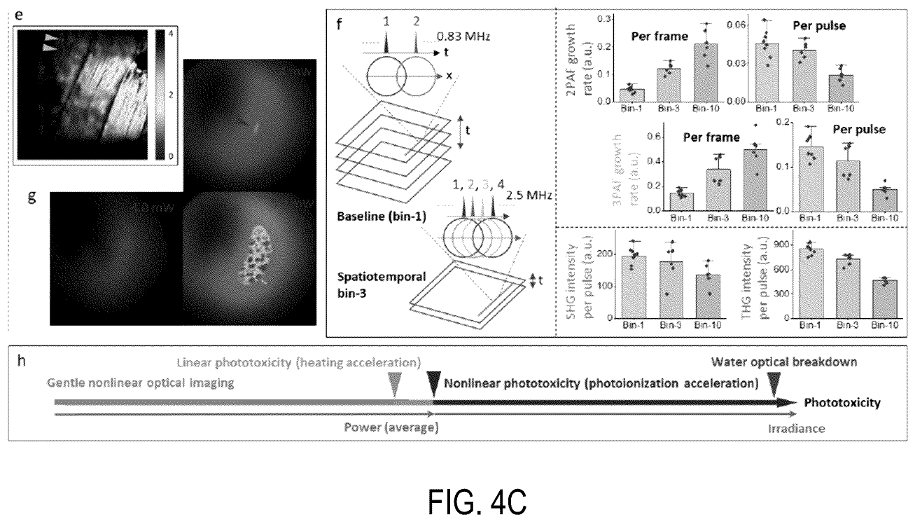

TABLE 7
Illuminations of pSLAM and eSLAM on chicken breast

| | pSLAM (galvo-galvo, ScanImage) | | | | |
|---|---|---|---|---|---|
| | | | | Spatio- | eSLAM |
| Microscope | | | | temporal | (resonant- |
| (optical scanner, | Baseline/ | | Spatial | bin-10 | galvo, |
| control software) | unchirped | Chirped | bin-3 | (or bin-3) | LabVIEW) |
| Central | 1030 nm | 1030 nm | 1030 nm | 1030 nm | 1110 nm |
| wavelength | | | | | |
| Pulse width on | 60 fs | 300 fs | 60 fs | 60 fs | 60 fs unchirped |
| sample (FWHM) | | | | | (or 300 fs |
| | | | | | chirped) |
| Bin: | 1 | 1 | 3 | 10/3 | 1 |
| pulses/pixel/frame | | | | | |
| Illumination P on | 2.0 mW | 4.0 mW | 2.0 mW | 20/6.0 mW | 18.7 mW |
| sample | | | | | |
| Pulse repetition | 0.83 MHz | 0.83 MHz | 0.83 MHz | 8.3/2.5 MHz | 5 MHz |
| rate | | | | | |
| Fast scan line rate | 340 Hz | 340 Hz | 113 Hz | 340 Hz | 1592 Hz |
| Pixel dwelling | 1.4 μs | 1.4 μs | 4.2 μs | 1.4 μs | 0.2 μs |
| time | | | | | |
| Exposure/ | 1.5/1.5 s | 1.5/1.5 s | 4.5/4.5 s | 1.5/1.5 s | 0.33/1.37 s |
| acquisition time | | | | | |
| per frame | | | | | |
| Illustrated in | FIG. 4A; FIG. | FIG. 4A, | FIG. 4A, | FIG. 4C, | FIG. 4B, |
| | 4C, set (f) | column (a) | column (b) | inset (f) | column (d) |

FIG. 3 illustrates the power threshold to generate WHF in chicken breast model by pSLAM (columns (a) and (b)) or eSLAM (column (c)). At the power threshold, spatially integrated 2PAF and 3PAF (i.e., WHF) signals may not (upper panels) or may (lower panels) increase with frame number during time-lapse imaging, using spatially integrated SHG signal as reference. Details of three illumination conditions are shown in Table 7 except for lower powers.

These results are in sharp contrast to the reported heterogeneous WHF where no linear growth rate and correlation to the illumination field has been established. In contrast to the heterogeneous WHF and bubble formation, the homogeneous WHF is more suitable for quantification due to the uniform morphology, independence on dosage, and linear growth at an early stage of phototoxicity. Under another illumination (see Table 7, baseline) except for a variable power, different FOVs in one sample of chicken breast at one controlled imaging depth (15±5 μm fixed) largely follows the power laws of nonlinear signals, with a small error of <20%. Chicken breast was therefore selected as a readily available model to reproducibly quantify the homogeneous WHF under different illuminations.

To evaluate the effect of pulse width on 2PAF/3PAF linear growth rates (arbitrary unit per pulse), two illuminations that were 10% above the corresponding WHF power thresholds (see Table 7, baseline vs. chirped) were compared, which produced consistent data cross different testing FOVs. FIGS. 4A-4C illustrate characteristic features of homogenous WHF-revealed phototoxicity. In FIG. 4A, column (a) shows: at top, reproducible 2PAF and 3PAF growth rates under the baseline illumination of time-lapse pSLAM imaging in two different FOVs of chicken breast, despite their difference in absolute intensity integrated over one frame; and at bottom, observed 2PAF and 3PAF growth rates under pSLAM baseline/unchirped illumination (upper left) and chirped illumination (upper right), along with calculated rates of the latter according to 2nd order phototoxicity (lower left) and 1st order or linear phototoxicity (lower right). Column (b) of FIG. 4A shows: at top, an illustration of spatial bin-3 illumination in comparison to baseline/bin-1 illumination; and at bottom, a comparison of 2PAF and 3PAF growth rates according to bin-1 (left) and bin-3 pSLAM illumination (right).

Column (c) of FIG. 4B shows: at top, high WHF-revealed phototoxicity but late bubble formation (arrowhead) at a high pSLAM irradiance; at middle, power-dependent 3PAF growth rates under chirped and unchirped/baseline pSLAM illuminations that reveal nonlinear phototoxicity; and at bottom, lower WHF-revealed phototoxicity but early bubble formation (arrowhead) at a higher pSLAM power. Column (d) of FIG. 4B shows: at top, tri-period eSLAM imaging of chicken breast that reveals linear phototoxicity at a low irradiance; and at bottom, similar tri-period imaging that reveals the emergence of nonlinear (photoionization-accelerated) phototoxicity and existence of heating-accelerated phototoxicity at a higher irradiance.

FIG. 4C shows, at image (e), FLIM imaging of a chicken breast sample containing eSLAM imaging-induced fluorescent compounds at a high irradiance, with color bar corresponding to lifetime in ns. Diagram set (f) includes, at left, an illustration of spatiotemporal bin-3 illumination in comparison to baseline/bin-1 illumination; and at right, a comparison of 2PAF/3PAF growth rate per frame/pulse and SHG/THG intensity per pulse under bin-1/3/10 pSLAM illumination. Image set (g) illustrates the determination of water optical breakdown threshold (arrowhead) by pSLAM baseline ‘imaging’ of 10-mM NADH solution. Finally, graph (h) shows a simplified view of phototoxicity and related thresholds versus power/irradiance free of cumulative multi-pulse effect.

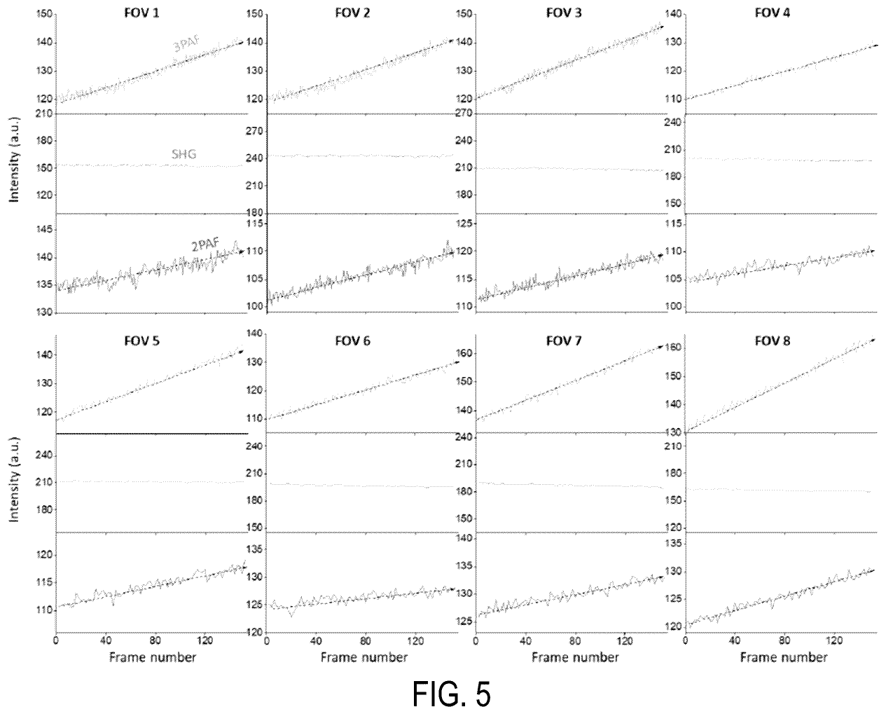

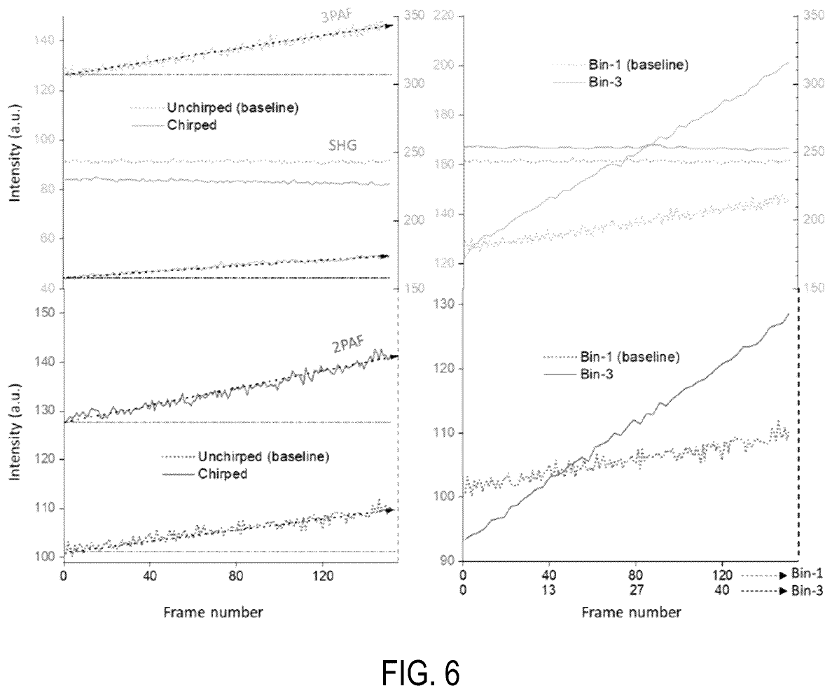

FIG. 5 shows reproducible 3PAF and 2PAF growth rates under the baseline pSLAM illumination across different FOVs in chicken breast. Spatially integrated 2PAF, 3PAF, and SHG signals during time-lapse imaging are plotted in the same intensity scales despite their difference in absolute intensity across FOVs. FIG. 6 shows the effect of pSLAM pulse chirping (left) or pulse spatial binning (right) on WHF growth rates. In comparison to unchirped/baseline illumination (60 fs, 2.0 mW), chirped illumination (300 fs, 4.0 mW) attains a higher 2PAF growth rate but a lower 3PAF growth rate. In comparison to bin-1 illumination (baseline), bin-3 illumination (60 fs, 2.0 mW) attains much higher 2PAF and 3PAF growth rates (note that signal intensity of the bin-3 illumination integrated over one frame is normalized by the number of binning).

By taking account of the dual role of excitation pulses to induce and detect WHF, the observed growth rates associated with the chirped illumination (see FIG. 6, left) can be predicted from those associated with the baseline illumination according to an assumed phototoxicity photon order of either 1 or 2. Because the former is in quantitative agreement with experimental data (see column (a) of FIG. 4A, bottom), the observed WHF is induced by linear absorption. This result is surprising because muscle samples such as chicken breast are not known as pigmented tissue, in contrast to mouse retina wherein the observed “luminescent flash” can be attributed to linear absorption/phototoxicity. It should be noted that two-photon “photo-enhancement” of rabbit red blood cells occurred more readily with longer pulses, implying a photon order of less than 2 (see Table 5). Moreover, the observed linear phototoxicity via WHF assay echoes that observed from mouse brain slices via the calcium microdomain hyperactivity in cortical astrocytes, which was attributed to the heating toxicity that can be detected offline after in vivo mouse brain imaging.

To assess the plausible role of heating in WHF, the line rate of fast scanning direction (x) in the baseline illumination was lowered at one pulse per pixel (diffraction-limited resolution of ˜0.4 μm) to bin 3 pulses spatially (see Table 7, spatial bin). Thus, one frame of the resulting bin-3 illumination (3 pulses/pixel) took the same time and light dose as three frames of the baseline/bin-1 illumination (1 pulse/pixel). This is further shown in FIG. 4B, top and FIG. 6, right. The constant laser repetition rate (0.83 MHz) separated successive pulses apart by 1.2 μs, a period much longer than the thermal relaxation time of water (0.06-0.14 μs). Thus, any heating effect in these illuminations would be dominated by single-pulse heating with no interference between successive pulses, which would form the starting point to reveal plausible cumulative multi-pulse heating by increasing the repetition rate. In other words, WHF growth rates of the bin-3 illumination would approximate those of the baseline illumination.

Unexpectedly, observed 2PAF (3PAF) growth rate in the bin-3 illumination is 4.8-time (3.4-time) of that in the baseline illumination (FIG. 4B, bottom and FIG. 6, right), indicating a non-heating cumulative multi-pulse effect. Consistently, the WHF power threshold in the bin-3 illumination is systematically lower than that of the baseline illumination. It is thus unlikely that the observed WHF originates from direct heating. In the context of lowered phototoxicity at increased scanning speed, the simplest alternative interpretation of this effect is the unrelaxed triplet after the linear absorption of specific intrinsic NIR photosensitizers, with a μs-scale lifetime prone to the excitation state absorption of successive pulses and subsequent high-order triplet-mediated ROS production. In contrast to the bin-3 illumination, the baseline illumination at 1 pulse/pixel avoids this ROS production by a faster scanning that spatially separates the individual pixels (excited photosensitizers in one cycle apart by ˜1 diffraction-limited resolution) without the cumulative multi-pulse effect, and thus relaxes the first-order triplet. Without this scanning in a laser tweezer largely free of temperature rise and heating, cw-NIR excitation with unrelaxed triplet has induced hyper-fluorescence and ROS-mediated phototoxicity to a trapped cell after a prolonged exposure (˜10 min).

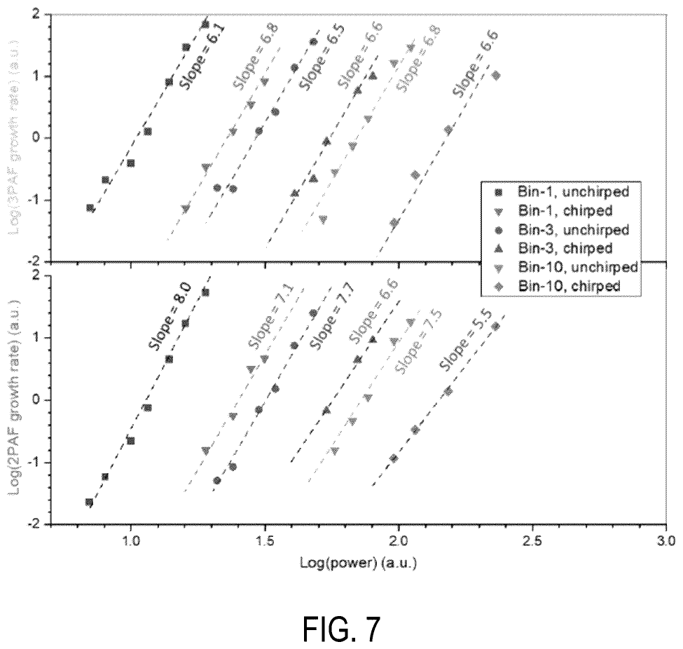

To evaluate the power-dependence of WHF growth rates, the baseline and chirped bin-1 pSLAM illuminations (free of the cumulative multi-pulse effect) were employed, except for larger powers up to ˜2-time of the corresponding WHF power thresholds. Interestingly, both illuminations led to a nonlinear WHF phototoxicity with an apparent photon order within 3-6, as can be seen from FIG. 7. In particular, FIG. 7 shows apparent photon orders of WHF growth rates revealed by 3PAF (top) and 2PAF (bottom) with/without pSLAM pulse chirping or spatiotemporal binning. The apparent photon orders vary across 6.1-6.8 for 3PAF (photon order 3), indicating a nonlinear phototoxicity of order 3.1-3.8. The related apparent photon orders vary across 5.5-8.0 for 2PAF (photon order 2), indicating a nonlinear phototoxicity of order 3.5-6.

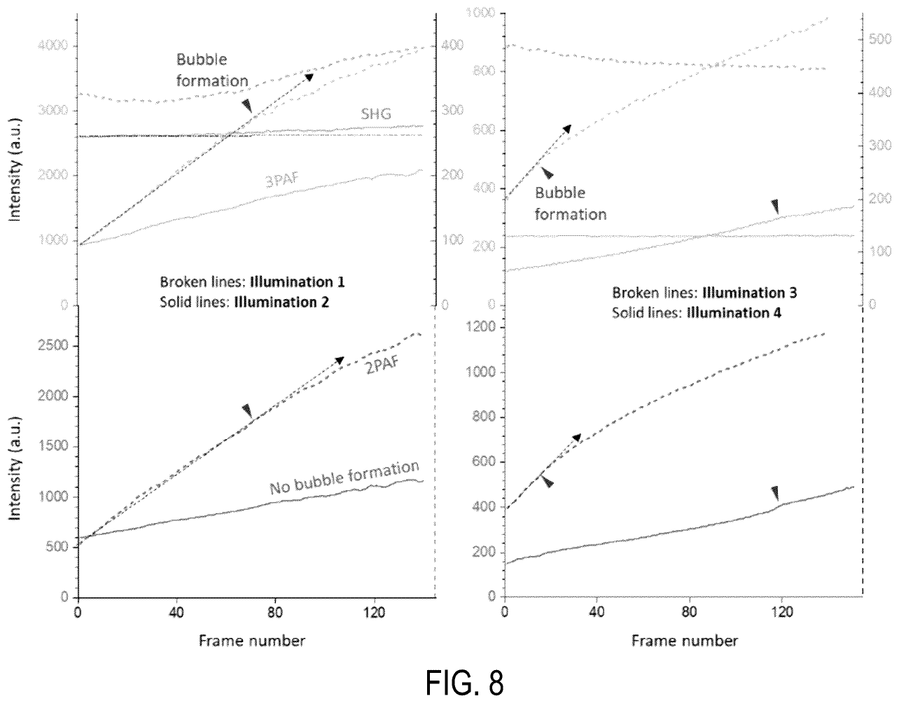

To identify the factor that accelerates the otherwise linear phototoxicity of WHF toward the nonlinear phototoxicity, the dynamics of high phototoxicity well above the WHF power threshold were examined. FIG. 8 presents an assessment of bubble formation (arrowheads) under different pSLAM illuminations. The left graph shows bubble formation at illumination 1 (0.83 MHz 60 fs, 3.0 mW) absent from illumination 2 at a lower power (0.83 MHz 60 fs, 2.6 mW); the right graph shows bubble formation at illumination 3 (0.83 MHz 300 fs, 5.9 mW) occurs earlier than at illumination 4 (5.0 MHz 300 fs, 20.9 mW) despite the higher power of the latter, indicating the larger role of single-pulse heating than overall thermal load to promote bubble formation. A comparison between Illumination 1 and Illumination 3 (or Illumination 2 and Illumination 4) reveals the larger role of photoionization than heating (relevant to bubble formation) to accelerate 3PAF/2PAF growth rates (i.e., phototoxicity). At the highest power of the baseline illumination, long-lasting bubbles formed near the 80th frame (see FIG. 4B, column (c), top), whereas a lower power did not form the bubbles after 120 frames (FIG. 8, left). In contrast, at the highest power of the chirped illumination, the bubble formation occurred at an earlier (˜15th) frame, but the growth rate from either 3PAF or 2PAF was at least 50% lower (FIG. 4B, column (c), bottom; FIG. 8, right). Given a common temperature threshold for bubble formation (˜130° C.), the latter should sustain a higher global temperature than the former throughout the imaging. Thus, WHF is mainly accelerated by single-pulse photoionization dictated by irradiance (unit: TW/cm²), not the heating dictated by average power (unit: mW). The resulting photoionization-accelerated WHF might overwhelm the otherwise progressively decreased SHG signal by thermal denaturing.

To generalize the results from pSLAM, the eSLAM microscope that replaced the prism-based compressor with a pulse shaper to electronically chirp 1110-nm pulses from 300 fs to 60 fs was employed. With the same spatially separated pulsed excitation (i.e., one-pulse-per-pixel imaging of the same FOV), the observed WHF power threshold increased from 1.8-mW in pSLAM to 17-mW in eSLAM (see FIG. 3). However, the corresponding irradiances (i.e., 2.2-nJ pulse energy at 1030-nm in pSLAM versus 3.4 nJ at 1110-nm in eSLAM) are comparable, indicating the single-pulse nature of phototoxic WHF (free of cumulative multi-pulse effect). This single-pulse effect also dominates the cumulative multi-pulse effect in bubble formation or heating toxicity (FIG. 8, right). Using a power 10% above the WHF power threshold (Table 7, eSLAM), a tri-period imaging with switchable pulse chirping was conducted and the same linear WHF growth rate was observed in the first and third periods, which was sustained by the second period even though the corresponding phototoxicity could not be detected by chirped pulses. This independently confirms the linear absorption nature of WHF observed in pSLAM.

To examine the plausible role of heating, a power ˜20% above the WHF power threshold was used and a much larger WHF growth rate was observed from the first period than that from the second period, which indicated the emergence of photoionization-based acceleration (see FIG. 4B, column (d), bottom). The WHF growth rate from the third period surpassed that from the first period considerably. If linearly absorbed light energy end ups more as heat than the photoionization-accelerated WHF during the second period in comparison to the first period, the higher WHF growth rate of the third period than that of the first period can be attributed to a higher global temperature. This implies that the global heating, which is superimposed on the single-pulse heating in eSLAM (with 0.2 μs pulse separation larger than the thermal relaxation time of 0.06-0.14 μs), accelerates WHF under a relatively low irradiance. This acceleration may be caused by the thermal inactivation of intrinsic ROS scavengers in addition to an increased ROS production. As an implication, it allows detection of linear phototoxicity by a chirping-pulse experiment (FIG. 4A, column (a), bottom; FIG. 4B, column (d), top) but not a conventional power-dependence experiment (FIG. 4B, column (c), middle; FIG. 7).

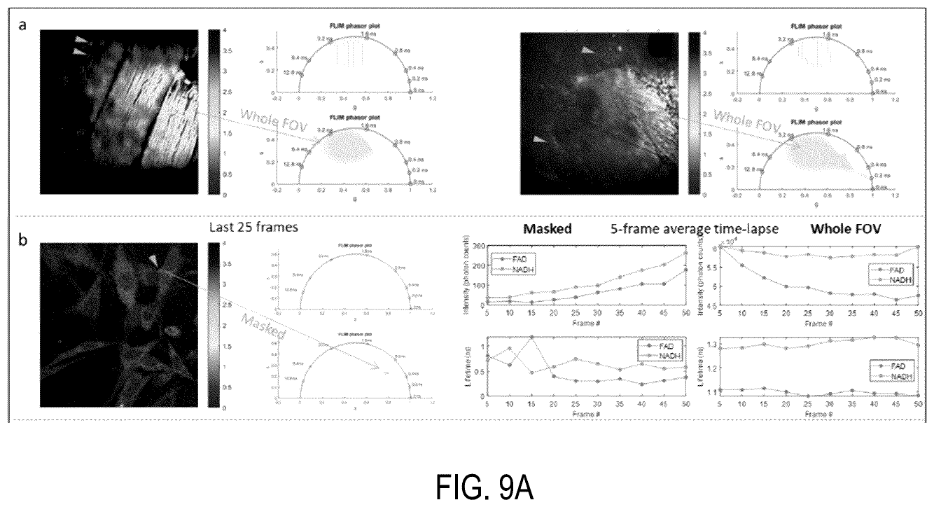

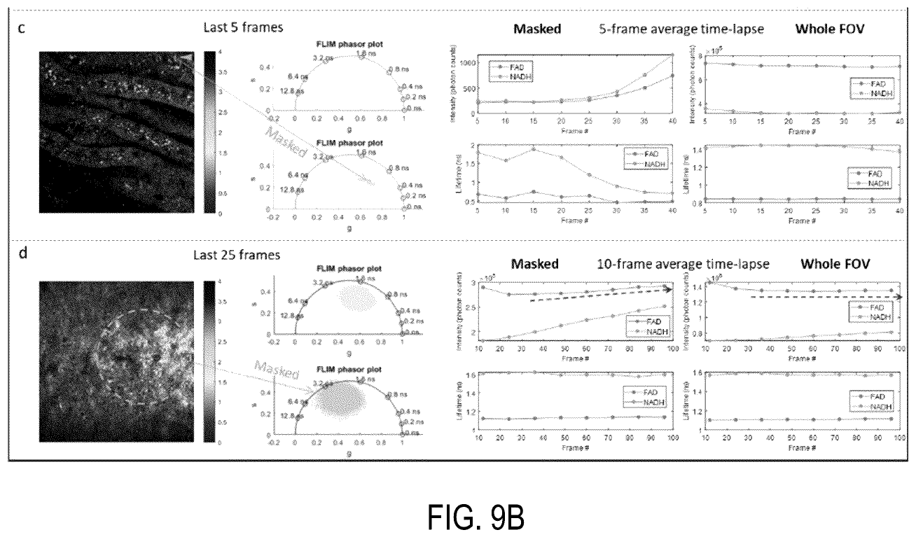

To measure the lifetime of WHF, the fluorescence lifetime imaging microscopy (FLIM) capability of the eSLAM microscope was invoked. The FLIM of WHF in cultured cells and ex vivo tissue is illustrated in FIGS. 9A and 9B, in which the color bar corresponds to a lifetime in ns. In FIG. 9A, row (a) shows a fluorescence lifetime and phasor plot (FAD-yellow; NADH-cyan) observed from two fresh chicken breast samples with homogeneous WHF (yellow center) and punctuated homogeneous WHF (arrowheads). Row (b) of FIG. 9A shows a heterogeneous WHF lifetime (arrowhead) and phasor plot observed from a hamster kidney cell in cell culture (left two panels) at 18 mW; right panels show time-lapse fluorescence intensity and lifetime corresponding to the heterogeneous WHF only (left) and whole FOV (right). In FIG. 9B, row (c) shows a heterogenous WHF lifetime (arrowhead) and phasor plot observed from ex vivo mouse kidney tissue (left two panels) at 18 mW; right panels show time-lapse fluorescence intensity and lifetime corresponding to the heterogeneous WHF only (left) and whole FOV (right). Row (d) of FIG. 9B shows a homogeneous WHF lifetime (broken cycle) and phasor plot observed from ex vivo mouse brain slice (left two panels) at 20 mW; right panels show time-lapse fluorescence intensity and lifetime corresponding to the homogeneous WHF only (left) and whole FOV (right).

The WHF was first induced in one FOV (˜15 μm imaging depth) by 200 scans at a rather high power to overwhelm the intrinsic fluorescence signal, and then FLIM imaging was conducted on the same FOV using a low power that did not further increase the WHF. The lifetime of homogeneous WHF (˜1.5 ns) is longer than that of heterogenous WHF (˜0.6 ns; see arrowheads in image (e) of FIG. 4C), which are comparable with those observed from cultured hamster kidney cells and ex vivo mouse kidney, as can be seen in FIGS. 2A, 9A, and 9B. Similar lifetimes (˜1 ns) were obtained from the NIR-induced “white flashes” of Chinese hamster cells and from new fluorescent compounds in NIR-ablated muscle and albumin samples, suggesting that similar fluorescent compounds produce the widely reported WHF in diverse cell/tissue samples (see Table 4).

The homogeneous WHF was also observed in a mouse brain slice via 3PAF but not 2PAF across the FOV, whereas the latter could reveal this WHF in a central region of FOV with the highest irradiance (see row (d) of FIG. 9B). From this result, it is believed that the photobleaching of strong intrinsic fluorescence often obscures the homogeneous WHF, which would otherwise be widely observable in live samples. The intrinsically weak 2PAF/3PAF signals of chicken breast offer a rather clean background at the beginning of time-lapse imaging for sensitive detection of the homogeneous WHF and accurate quantification of the phototoxicity.

In contrast to the spatial bin-3 illumination that binned 3 pulses into one spot spatially (FIG. 4A, column (b), top), the more popular binning affordable by the flexible galvo-galvo scanning and tunable repetition-rate laser of pSLAM was to bin multiple pulses into one spot spatiotemporally at the same fast-axis scanning speed of the baseline illumination. To evaluate the benefit/cost of this spatiotemporal binning, imaging was performed on different FOVs at bin-1 (baseline), bin-3, and bin-10 conditions with different powers (repetition rates) but the same pulse energy. Unlike the spatial binning case, the WHF growth rate per pulse decreases with the bin number possibly due to saturated absorption of the photosensitizers. However, this benefit is countered by the cost of lowered nonlinear signals, which may be attributed to unrelaxed photoionization with up to 300 ns lifetime of solvated electrons. The corresponding cumulative multi-pulse effect produces similar nonlinear phototoxicity (see FIG. 7). However, it lowers the WHF irradiance threshold due to a higher WHF growth rate per frame. Thus, it may be more beneficial to increase the throughput of the pSLAM baseline imaging by the bin-1 (no-bin) illumination of eSLAM, free of the cumulative multi-pulse effect that likely impaired embryo development. This eSLAM illumination relaxes the linear-absorption-mediated triplet by combining a higher repetition-rate excitation with a proportionally faster scanning, and thus attains the same one-pulse-per-pixel imaging across the same FOV (see Table 7).

To estimate the optical breakdown threshold of water, the pSLAM baseline illumination was conducted on a 10-mM solution of reduced nicotinamide adenine dinucleotide (NADH) at different pulse energies, which identified a threshold of 5.3-nJ corresponding to 9.3 TW/cm² at 1030-nm (near identical threshold was attained at 1110-nm). This threshold approximates the theoretical value of 3.9-nJ or ˜7 TW/cm² (1064-nm, 100-fs, NA 1.3). Thus, gentle imaging free of unrelaxed triplet and subsequent ROS production (detectable WHF in FIG. 3) can be conducted at a surprisingly large ratio (˜50%) of water breakdown threshold (normalized irradiance in Table 8). The irradiance/power-dependent phototoxicity becomes clear without the interfering cumulative multi-pulse effect. Note that, in Table 8, normalized irradiance was determined by water optical breakdown across 1030-1110 nm. For model WHF, the normalized irradiance was adjusted for measured M²ᵥₐₗᵤₑ of 1.10 for the pSLAM laser source of 1.16 for the eSLAM laser source. Future fast optical metabolic imaging is assuming that linear phototoxicity onset is limited by single-pulse heating.

TABLE 8
Normalized threshold irradiance of NIR phototoxicity versus number of pulses per diffraction-limited-resolution

| | | FWHM | Pulse | | | | Diffraction | Fast-axis | |
|---|---|---|---|---|---|---|---|---|---|
| Photo- | Wave- | pulse | repetition | Average | Pulse | | limited | scan speed | Normalized |
| toxicity | length | width | rate | power | energy | NA of | resolution | in μm/ms | irradiance |
| assay | (nm) | (ps) | (MHz) | (mW) | (nJ) | objective | (μm) | (PPD) | (%) |
| Model | 1110 | 0.06 | 5.0 | 17 | 3.4 | 1.15 | 0.48 | 1600 | 49 |
| WHF | | | | | | | | (1.5) | |
| (eSLAM) | | | | | | | | | |
| Model | 1030 | 0.06 | 0.83 | 1.8 | 2.2 | 1.15 | 0.45 | 290 | 41 |
| WHF | | | | | | | | (1.3) | |
| (pSLAM) | | | | | | | | | |
| Ca | 1300 | 0.04 | 0.8 | 1.6 | 2.0 | 1.05 | 0.62 | ~600 | 37 |
| response | | | | | | | | (~1) | |
| Laser | 800 | 0.1 | 76 | 60 | 0.79 | 0.8 | 0.50 | ~2 | 8.6 |
| surgery | | | | | | | | (~1.4 × 10⁴) | |
| Skin | 780 | 0.1 | 0.01 | 0.0035 | 0.35 | 1.2 | 0.33 | No | 9.4 |
| cavitation | | | | | | | | scanning | |
| Retina | 750 | 0.075 | 8.0 | 1.8 | 0.23 | 1 | 0.38 | ~200 | 5.5 |
| WHF | | | | | | | | (15) | |
| Photo- | 781 | 1.2 | 80 | 52 | 0.65 | 0.7 | 0.56 | ~200 | 0.5 |
| toxicity | | | | | | | | (22) | |
| indicator | | | | | | | | | |
| Ca²⁺- | 775 | 100 | 80 | 140 | 1.75 | 1.4 | 0.28 | ~2.2 × 10³ | 0.1 |
| indicated | | | | | | | | (~14) | |
| stress | | | | | | | | | |
| Lipid | 711 | 2 | 1 | 2 | 2 | 1.2 | 0.30 | ~50 | 3 |
| motility | | | | | | | | (~6) | |
| Myelin | ~750 | 2.5 | 7.8 | 8.8 | 1.1 | 1.2 | 0.31 | ~100 | 1.3 |
| WHF | | | | | | | | (~24) | |
| Astrocyte | 920 | 0.1 | 80 | 17 | 0.21 | 0.95 | 0.48 | ~24 | 2.3 |
| hyper- | | | | | | | | (~1.5 × 10³) | |
| activity | | | | | | | | | |
| Cell | 780 | 0.17 | 80 | 7.3 | 0.091 | 1.3 | 0.30 | ~5 | 1.6 |
| viability | | | | | | | | (~6.2 × 10³) | |
| Cell WHF | 730 | 0.15 | 80 | 6 | 0.075 | 1.25 | 0.29 | ~2 | 1.6 |
| | | | | | | | | (~1.5 × 10⁴) | |
| Future | 800 | 0.06 | 20 | 8 | 0.4 | 1.25 | 0.32 | 9000 | 19% |
| fast | | | | | | | | (1) | |
| optical | | | | | | | | | |
| metabolic | | | | | | | | | |
| imaging | | | | | | | | | |
| Future | 1110 | 0.06 | 20 | 36 | 1.8 | 1.15 | 0.48 | 9000 | 41% |
| fast | | | | | | | | (1) | |
| eSLAM | | | | | | | | | |

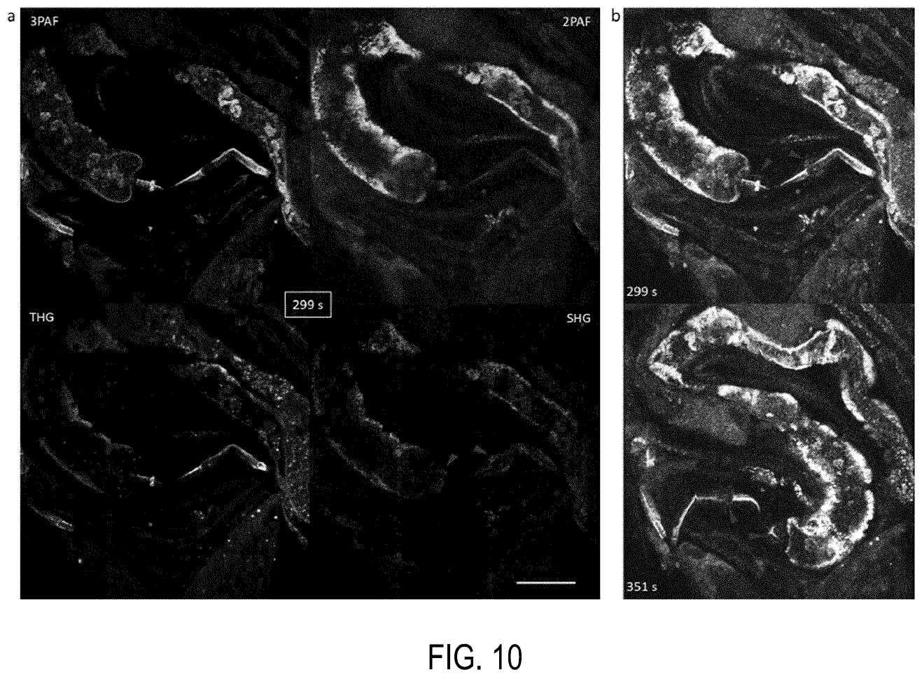

To highlight the “gentle” eSLAM imaging operated near one-half of water breakdown threshold, wide-type unlabeled C. elegans in standard culture (OP50) was investigated. All signals were epi-detected and displayed at 0.73 Hz frame rate (1024×1024-pixel frame) without image denoising/reconstruction. The free motion of one worm was observe with 0.2-μs pixel dwell time and its moving 3PAF-visible pharynx and related pair of SHG-visible bulbs were identified. FIG. 10 illustrates the gentle eSLAM imaging of the unlabeled moving C. elegans (14.4 mW on sample). Image (a) presents instant single-frame images of one worm with 3PAF/cyan-visible pharynx (arrow) and a pair of SHG/green-visible bulbs (arrowheads); similar pharynx structure (star) indicates the presence of multiple worms in the same field of view. Image (b) presents related time-lapse imaging of the worm (arrowheads) with 0.33 s exposure per frame and 1.37 s between successive frames; related video reveals THG/magenta-visible embryos and uterus, 3PAF/cyan-visible proximal and distal gonads with internal germ cells or oocytes, 3PAF/THG-visible intestine, and 2PAF/yellow-visible body wall muscle. The scale bar is 50 μm. Similar results, including the SHG-visible bulbs, were obtained in less adaptive transmission configuration with 5-μs pixel dwell time that necessitated animal immobilization. It is unprecedented to observe strong back-reflected SHG signal from transparent samples such as C. elegans. This demonstration highlights the potential of eSLAM to translate label-free nonlinear optical imaging.

The coexistence of linear and nonlinear NIR phototoxicity observed in the above-described WHF assay (at low and high powers, respectively) builds on a comparative observation at ˜30-fold lower irradiance and reconciles the existence of either linear or nonlinear NIR phototoxicity in various WHF-like assays and bioassays. Apparently nonlinear phototoxicity originates from the linear NIR absorption of ubiquitous intrinsic NIR photosensitizers, just like that from the excessive (high-power) linear absorption of intrinsic UV-visible photosensitizers. Thus, the apparent photon order of ≥2 in the observed phototoxicity does not imply a multiphoton absorption, as would be assumed. In other words, the concept of photon order is useful to characterize the nonlinearity of molecular absorption and harmonic generation but not a phenomenological phototoxicity. Without this “evidence” that has strongly supported the nonlinear-absorption-mediated phototoxicity, other evidence can be reinterpreted to be compatible with the hypothesized mechanism of linear-absorption-mediated nonlinear phototoxicity. To avoid the relevant accelerated ROS production in (clinical) nonlinear optical imaging, one may to relax the triplet state by increasing the fast-axis scanning speed (or pulses per diffraction-limited-resolution PPD, just like in linear optical imaging. The increased scanning speed allows real-time sensitive monitoring of phototoxicity via WHF and unambiguous identification of a non-fluence (power, irradiance, intensity, etc.) threshold with minimal doses. Therefore, the above-described experimental study tips the balance from the comparative view of pulsed-NIR phototoxicity based on a fluence threshold toward the contradictory view based on an irradiance threshold.

A source of confusion in the art on observed NIR phototoxicity arises from the existence of different relaxation time scales of >1 μs (photochemistry), ˜0.3 μs (photoionization), and ˜0.1 μs (heating) to produce different extents of cumulative multi-pulse effect. This effect is prevalent in the illumination (galvo-galvo scanning of ˜80 MHz pulses) of nonlinear optical imaging and may have obscured the hypothesized mechanism. By resonant-galvo scanning of ˜5 MHz pulses to remove this effect (so that subsequent pulses address well-resolved pixels ˜1 diffraction-limit resolution apart, i.e., triplet-relaxation in eSLAM), gentle imaging can be conducted at ˜50% of water optical breakdown before the linear/nonlinear phototoxicity onset of single-pulse heating/photoionization. Without this relaxation, laser surgery can occur at only 8.6% of water optical breakdown. Also, accelerated phototoxicity by cumulative multi-pulse heating may induce linear-absorption-mediated nonlinear phototoxicity at ≤3% of water optical breakdown (largely free of single-pulse photoionization), resembling the single-pulse heating in the picosecond excitation of coherent anti-Stokes Raman scattering microscopy with this relaxation. This role of single-pulse heating is further validated by the low phototoxicity onset below 10% of water optical breakdown in pigmented specimens of skin and retina, and the absence of reported WHF in low-power UV-visible confocal fluorescence microscopy. However, the hypothesized mechanism attributes the corresponding linear phototoxicity more to unrelaxed triplet and subsequent heating-accelerated ROS production than direct heating.

The eSLAM irradiance threshold from the chicken breast model has been tested in diverse cultured cells and ex vivo or in vivo mouse tissue specimens. An irradiance 10% more than this threshold consistently generates WHIF in time-lapse imaging whereas an irradiance 10% less than this threshold avoids the WHF completely. This test not only validates the assertion of a non-fluence threshold below which dose becomes irrelevant, but also the ability of WHF (or chicken breast) as a real-time inline indicator (or a “natural” tissue-mimicking phantom) for phototoxicity. The intrinsic WHF avoids the limitations of the photobleaching of specific extrinsic fluorophores to indicate subtle/early phototoxicity and restricts more severe phototoxicity of damage to nucleus and morphology. Thus, short (sub-80-fs) pulse is preferred over longer (picosecond) pulses to not only increase nonlinear signal generation near linear phototoxicity onset but also detect this onset more sensitively than 300-fs pulses within a narrow window of linear phototoxicity. As to the pulse repetition rate for triplet-relaxation, the choice depends on the trade-off between imaging depth (5-MHz of eSLAM preferred) and speed (20-MHz fast version of eSLAM preferred), both of which are subjective to the constraint of global heating. The preferred repetition rate to balance this tradeoff lies within the 5-20 MHz range. Either way, the hypothesized mechanism offers a universal technique to mitigate the NIR phototoxicity absent from the comparative mechanism. Further improvements may enable a more complete triplet-relaxation without spatial under-sampling and a higher throughput via volumetric imaging, while neutralizing heat/ROS generation may mitigate phototoxicity in vitro.

For pigmented samples, 3PAF imaging of NDAH at 1110-nm (eSLAM) may outperform comparative 2PAF imaging of NDAH at 750-780 nm due to low linear absorption of melanin (single-pulse heating) at longer wavelengths. The emergence of WHF reveals the otherwise invisible myofibrils in chicken breast, suggesting an origin of fluorescent Schiff base in lipofuscin-like products from the peroxidation of polysaturated lipids that crosslinks proteins. The WHF may be generalized as a form of oxidation-induced fluorescence from light exposure, paralleling that from heating/cooking, storage-induced meat deterioration or natural aging, and chemical induction. However, the dependence of NIR phototoxicity on wavelength may rely more on the absorption properties of photosensitizers (initiator) and plausible heat-generating pigments or chromophores (accessory) than those of the resulting species emitting WHF (end-product). In summary, with rapidly scanned sub-80-fs excitation to fully relax the triplet state, the unfulfilled potential of laser-scanning nonlinear optical microscopy in gentle imaging may be rationally recovered.

In the above-described experimental verification, pSLAM and eSLAM microscopes were used. Several independent parameters of the pSLAM and eSLAM illuminations are compared in Table 7. Average power at the sample plane was measured by a microscope slide power meter (S175C, Thorlabs). The M² value of pSLAM laser source (1.10) or eSLAM laser source (1.16) was measured by a commercial device (M2MS, Thorlabs) to calculate irradiance. All imaging experiments were conducted at room temperature with no additional temperature control of cell/tissue samples. Adherent Syrian golden hamster kidney fibroblast cells (BHK-21, clone 13, ATCC #CCL-10) were cultured in disposable BioLite™ 75 cm² vented-cap cell culture treated flasks according to supplier-recommended protocols. They were maintained inside a humidified incubator with 5% CO₂ and 21% O₂ conditions at 37° C. A 0.5-1 mL volume of harvested cells was resuspended in 1.5-1 mL of phenol red-free Gibco™ 1X TrypLE™ Select Enzyme (pH 7.0-7.4) cell dissociation reagent (TFS, Cat #12563029) in triplicates. The cells were imaged within 10 min of the resuspension. C. elegans growing on agar plates seeded with E. coli were obtained from Carolina Biological Supply Company. After additional growth of 2-4 days, a small portion was cut out of the agar plate and placed in a dish (P35G-0-10-C, MatTek) for imaging. Fresh chicken breast was purchased from a local supermarket, cut by a razorblade with a smooth surface, and imaged within 24 hrs. All experiments on rodents were performed in compliance with the Guide for Care and Use of Laboratory Animals of the National Institutes of Health and approved by the Institutional Animal Care and Use Committee at the University of Illinois at Urbana-Champaign (Animal Welfare Assurance #A3118-01). Brains of 4-week Long-Evans rats from an inbred colony (LE/BluGill) were removed and immersed in ice-cold slicing media (93 mM N-Methyl-D-glucamine, 2.5 mM KCl, 1.2 mM NaH₂PO₄, 30 mM NaHCO₃, 20 mM HEPES, 25 mM glucose, 2 mM Thiourea, 3 mM Sodium pyruvate, 10 mM MgSO₄, 0.5 mM CalCl₂, pH 7.4) bubbled with CO₂. Coronal slices (400 μm) containing the medial suprachiasmatic nucleus (SCN) were sectioned by a vibratome (Leica VT1000S). Slices were transferred to tissue culture inserts (0.4 μm; Millicell-CM, Millipore) contained within 35 mm tissue culture dishes. The dishes were immersed in 1 mL of organotypic media, i.e., DMEM without sodium pyruvate supplemented with 10 mM HEPES, GS21 (1:50, GlobalStem), Penicillin-Streptomycin (1:100, ThermoFisher Scientific) and 1 mM L-glutamine. Cultures were kept at 37° C. in 5% CO₂ and media were exchanged every other day. Brain slices kept in culture for <1 week were used for imaging. Mice (C57BL/6J, Jackson Laboratory) were used to obtain ex vivo kidney samples, which were imaged directly without specific preparation.

### EXAMPLE IMPLEMENTATIONS

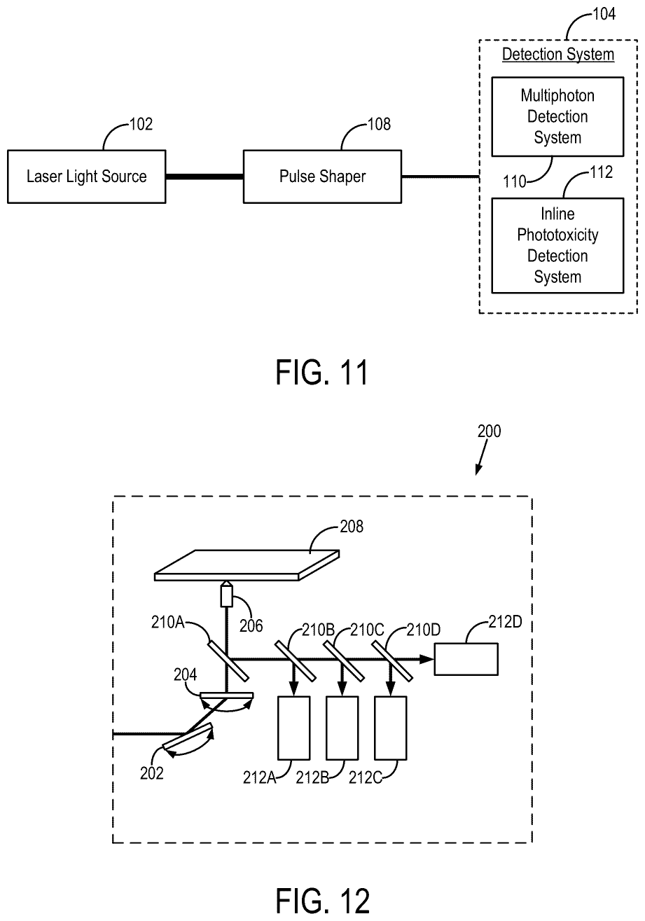

Referring now to FIG. 11, an example imaging system 100 that is configured for simultaneous label-free autofluorescence-multiharmonic (SLAM) microscopy is illustrated. The system 100 generally includes a laser light source 102 and a detector system 104. In some embodiments, the imaging system 100 may be configured as a portable SLAM (pSLAM) imaging system. Alternatively, the imaging system 100 may be configured as an extended SLAM (eSLAM) imaging system.

The laser light source 102 can generally include a femtosecond laser. As one example, the laser light source 102 can include an extended cavity laser. As another example, the laser light source 102 can include a mode-locked laser, such as a mode-locked Yb:fiber laser. In still other examples, the laser light source 102 can include other solid-state bulk lasers, fiber lasers, semiconductor lasers, microchip lasers (e.g., Q-switched microchip lasers), or the like.

As mentioned above, the laser light source 102 is generally a femtosecond laser. The laser light source 102 may, for example, generate a single laser pulse with a wavelength band of 1110±30 nm, a pulse repetition rate on the order of a few megahertz (e.g., approximately 5 MHz), a pulse width on the order of 60 femtoseconds (e.g., which may be ensured by a pulse shaper 108), and an average power of 50 mW. The pulse shaper 108 can include a 4f pulse shaper based on a spatial light modulator, or alternatively, may include a pulse compressor, such as a prism, a grating pair, or the like. However, the laser light source 102 may also emit pulses having different wavelengths, pulse repetition rates, pulse durations, and average powers.

The output beam of the pulse shaper 108 is then transmitted to the detection system 104. In general, the detection system 104 includes a multiphoton detection system 110 and an inline phototoxicity detection system 112. The inline phototoxicity detection system 112 may be a part of the multiphoton detection system 110, or may be a physically separate detection system. For instance, as one non-limiting example, the multiphoton detection system 110 can collect observed light using one or more high-sensitivity detectors, such as one or more photomultiplier tubes (“PMTs”). As a non-limiting example, a different PMT (or group of PMTs) can be used for each different imaging contrast (e.g., 2PAF, 3PAF, 4PAF, SHG, THG, etc.). Thus, in some implementations, the inline phototoxicity detection system 112 may correspond to a PMT or group of PMTs in the multiphoton detection system 110 that is configured to collect optical signal data that are indicative of phototoxicity. As an example, the inline phototoxicity detection system 112 can be configured to collect optical signal data as blue hyperfluorescence.

In some embodiments, the detection system 104 can include a laser scanning microscope. For instance, in some embodiments, the detection system 104 can include a laser scanning microscope configured to simultaneously collect multiple different imaging contrasts corresponding to multiple different photon orders, and can scan the laser light source 102 at a moderately fast speed (e.g., 1.5 m/s), such that one image pixel can be acquired per pulse. More generally, the observed light is collected by the detection system 104 using one or more PMTs.

As noted, in some embodiments the detection system 104 includes a laser scanning microscope. One such example is illustrated in FIG. 12. In these instances, the laser scanning microscope 200 can generally include scanning mirrors 202 and 204, an objective 206, and a specimen stage 208.

The scanning mirrors 202 and 204 allow for raster scanning of the incoming light beam from the pulse shaper 108. As a non-limiting example, the scanning mirrors 202 and 204 may be galvanometer mirrors. In an example configuration, the objective 206 may be a high-UV transmission objective with a relatively low magnification (such as 40×), but a relatively high numerical aperture (such as 1.15). This combination of raster scanning and relatively low magnification objective enables a field-of-view of on the order of 0.4×0.4 mm², with an average power of 14 mW incident on a sample on the specimen stage 208 after the loss along the excitation beam path.

The specimen stage 208 may hold a biological sample containing a plurality of fluorophores of interest, harmonophores of interest, or combinations thereof. As noted above, examples of fluorophores can include FAD, other flavoproteins or flavoprotein-like fluorophores, NADH, nicotinamide adenine dinucleotide phosphate (NADPH), tryptophan, genetically encoded calcium indicators, and dyes such as DRAD5, among others. Examples for harmonophores include collagen (SHG) and lipid (THG).

The laser scanning microscope 200 may in some configurations include dichroic mirrors 210A-210D and PMTs 212A-212D to separate the light emitted by the fluorophores and/or harmonophores into spectrally distinct channels. The incoming beam from the pulse shaper 108 is sent through scanning mirrors 202 and 204, dichroic mirror 210A, and objective 206 to the specimen stage 208.

Dichroic mirror 210A is used to separate the excitation beam from the light emitted by the fluorophores and/or harmonophores in the sample on the specimen stage 208. To this end and as an example, dichroic mirror 210A may have a 50%-cut-off edge wavelength (edge) of 750 nm so that light with a wavelength of less than 750 nm is reflected towards the PMTs 212A-212D. The PMTs 212A-212D may be photon-counting PMTs, analog PMTs, or the like, and may include bandpass filters (not shown in FIG. 12) that work together with the dichroic mirrors (e.g., dichroic mirrors 210B-210D) to collect spectrally resolved multimodal multiphoton signals in the PMTs 212A-212D.

As a non-limiting example, PMT 212A may include a filter that allows light with wavelengths between 365 nm and 375 nm to pass. The corresponding dichroic mirror 210B may have an edge of 409 nm, so that light below the edge wavelength is reflected into the photomultiplier 212A. The remaining light is sent to dichroic mirror 210C, which may have an edge of 506 nm. Therefore, light with a wavelength lower than 506 nm is reflected into PMT 212B. The PMT 212B includes a filter that allows light with wavelengths between 420 nm and 480 nm to pass. The remaining light that passes dichroic mirror 210C is sent to dichroic mirror 210D. Dichroic mirror 210D may have an edge of 570 nm. Light below the edge wavelength is reflected into PMT 212C, while light above the edge wavelength is sent to PMT 212D. PMT 212C may include a bandpass filter that allows light with wavelengths between 540 nm and 570 nm to pass, and PMT 212D may include a bandpass filter that allows light with wavelength between 580 nm and 640 nm to pass. It will be appreciated by those skilled in the art that the edge wavelengths of dichroic mirrors 210A-210D and the bandpass filter wavelengths of PMTs 212A-212D described above are illustrative examples only. Any combination of mirror edge wavelength and bandpass filter wavelength that minimize crosstalk between individual channels and that lead to spectrally resolved, distinct signals generated by the PMTs 212A-212D may be chosen by the skilled person.

The four channels detected by the photomultipliers 212A-212D may correspond to light generated by the fluorophores and/or harmonophores in different modalities. For example, the four channels may represent THG, 3PAF, SHG, and 2PAF. However, any other modality or fluorescence process may be imaged through similar PMTs arrays detecting light generated by the corresponding molecules. Examples of other modalities and processes are first harmonic scattering, four-photon excited fluorescence of ultraviolet fluorophores (e.g., tryptophan), three-photon excited fluorescence of green fluorescent proteins (e.g., GCaMP-based calcium indicators), two-photon excited fluorescence of red/near-infrared dyes (e.g., DRAD5), and one-photon excited fluorescence of near-infrared fluorophores (i.e., carbon nanotube-based agents).

As described above, in some configurations the inline phototoxicity detection system 112 is integral to the multiphoton detection system 110. In these instances, a PMT 212 may be dedicated to acquiring optical signal data indicative of phototoxicity, or may acquire these data in addition to other optical signal data from the sample and/or specimen. As one non-limiting example, a PMT 212 can include a bandpass filter corresponding to a range of wavelengths associated with blue hyperfluorescence, and may be paired with a dichroic mirror 210 having an edge associated with a wavelength associated with blue hyperfluorescence.

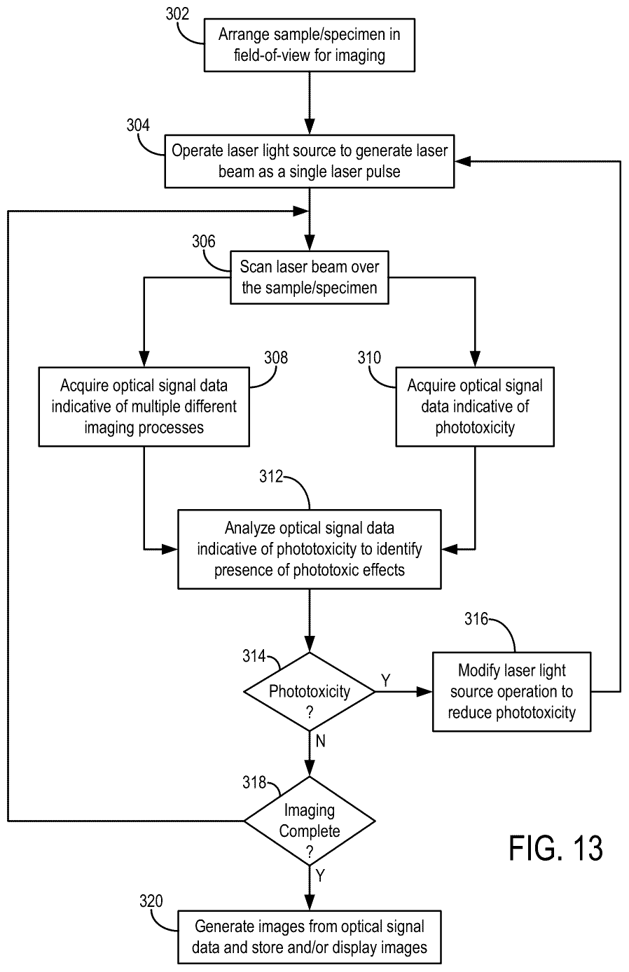

Referring now to FIG. 13, a flowchart is illustrated as setting forth the steps of an example method for multiphoton microscopy and/or imaging using the techniques described in the present disclosure.

The method includes arranging a sample and/or specimen within a field-of-view of the multiphoton microscopy and/or imaging system, as indicated at step 302. For instance, arranging the sample and/or specimen within the field-of-view can include arranging the sample and/or specimen on a stage (e.g., stage 208) for imaging.

The laser light source is then operated to generate a laser beam, as indicated at step 304. As described above, the laser beam may be engineered to facilitate multiphoton imaging through a λPOEM technique, or using other techniques described in the present disclosure. For instance, the laser beam can be generated as a single laser pulse with a repetition rate of approximately 5 MHz, a pulse width of approximately 60 fs FWHM, and a spectral band centered at approximately 1110 nm. The laser beam is scanned over the sample, as indicated at step 306, to generate optical signal data that are collected by multiple high-sensitivity detectors, such as PMTs. For example, the laser beam can be scanned at a moderately fast speed (e.g., approximately 1.5 m/s) to acquire one image pixel of optical signal data per pulse of the laser beam.

The optical signal data are collected by the multiple high-sensitivity detectors such that multiple different imaging modalities, contrasts, and/or processes can be simultaneously and independently measured, as indicated at step 308. For example, a first PMT can acquire optical signal data indicative of a 2-photon order imaging process, such as 2PAF; a second PMT can acquire optical signal data indicative of a 3-photon order imaging process, such as 3PAF; and a third PMT can acquire optical signal data indicative of a 4-photon order imaging process, such as 4PAF. Additionally or alternatively, other PMTs can be implements to acquire optical signal data indicative of other n-photon order imaging processes. For instance, a one or more additional PMTs can acquire optical signal data indicative of other 2-photon order imaging processes, such as 2 PF and/or SHG; other 3-photon order imaging processes, such as THG; 1-photon order imaging processes, such as optical coherence tomography and/or confocal reflectance microscopy; and so on.

Simultaneously, optical signal data indicative of phototoxicity are also acquired, as indicated at step 310. For instance, a dedicated PMT, or one of the PMTs used to acquire optical signal data in concurrent step 308, can be configured to acquire optical signal data as blue hyperfluorescence, which can indicate phototoxicity such as photodamage. These phototoxic effects can lead to protein denaturation, DNA damage, and oxidative stress. Thus, it is an advantage of the present disclosure that the optical signal data indicative of phototoxicity can be monitored in real-time while multiphoton microscopy and/or imaging is being performed. These optical signal data indicative of phototoxicity can be analyzed to assess whether phototoxic effects are present in the sample and/or specimen, as indicated at step 312. For example, the optical signal data indicative of phototoxicity can be compared to reference data that indicate the presence of photodamage at the relevant wavelengths. When photodamage or other phototoxic effects are identified in the optical signal data indicative of phototoxicity, the operating parameters of the laser light source can be modified to reduce or otherwise eliminate the photodamage, as determined at decision block 314 and implemented at step 316. For example, the pulse duration and/or pulse power can be modified to reduce photodamage. Additionally or alternatively, the laser light source can be turned off to prevent photodamage to the sample and/or specimen. In some implementations, a measure of the phototoxic effects to the sample and/or specimen can be displayed to a user in real-time, such that the user can manually adjust the operation of the laser light source to reduce photodamage to the sample and/or specimen.

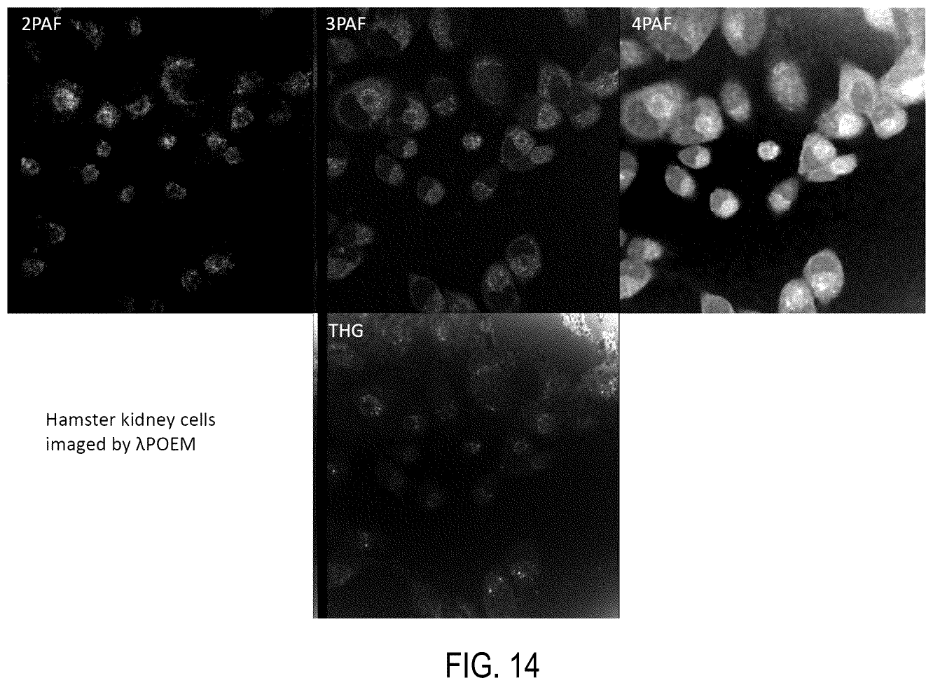

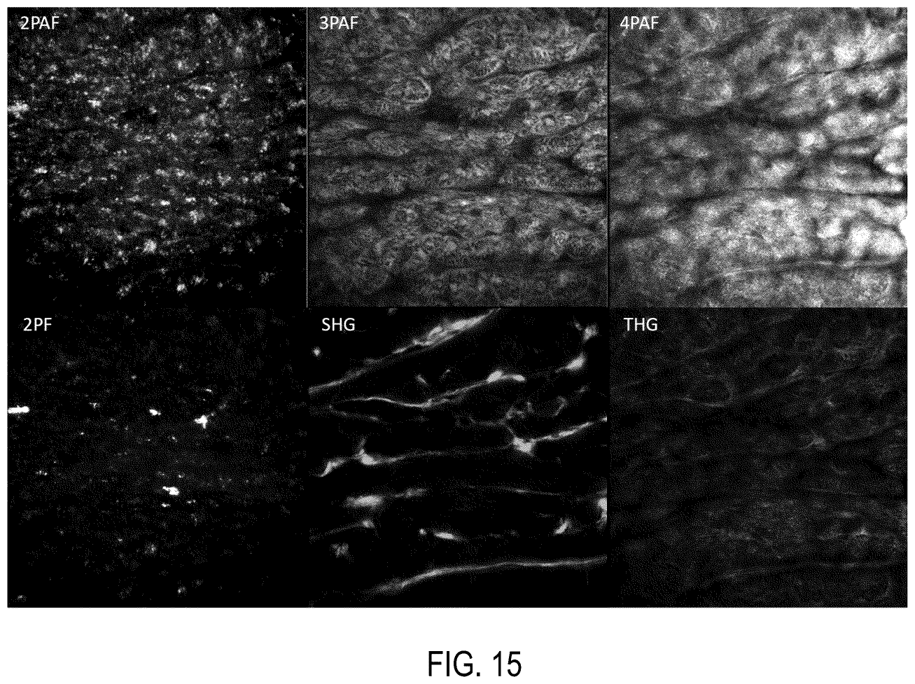

After imaging of the sample and/or specimen has been completed, as indicated at decision block 318, the optical signal data are stored for later use and/or displayed to a user, as indicated at step 320. For instance, images can be reconstructed or otherwise generated from the optical signal data, with different images corresponding to the different imaging modalities, contrasts, and/or processes that were simultaneously measured by the multiphoton microscopy and/or imaging system. As a non-limiting example, images corresponding to 2PAF, 3PAF, 4PAF, and THG can be acquired, as shown in the example image set illustrated in FIG. 14. As another example, images corresponding to 2PAF, 3PAF, 4PAF, 2 PF, SHG, and/or THG can be acquired, as shown in the example image set illustrated in FIG. 15. It will be appreciated by those skilled in the art that any suitable combination of the imaging modalities, contrasts, and/or processes described in the present disclosure can be simultaneously measured using the λPOEM or other techniques described in the present disclosure.

The images can be further processed to assess the health or characteristics of the sample and/or specimen. For instance, the images can be further processed to quantify or otherwise characterize one or more metabolites, such as FAD from 2PAF images, NAD (P)H from 3PAF images, and/or tryptophan from 4PAF images.

The present disclosure has described one or more preferred embodiments. However, the invention has been presented by way of illustration and is not intended to be limited to the disclosed embodiments. It should be appreciated that many equivalents, alternatives, variations, and modifications, aside from those expressly stated, are possible and within the scope of the invention.

What is claimed is:

1. A method for multiphoton microscopy, the method comprising:
exciting a biological sample using a light source that is rapidly scanned over the biological sample to increase triplet relaxation in the biological sample;
simultaneously detecting light emitted by molecules in the biological sample in a plurality of colors; and
creating an image or a temporal series of images from the light detected in the plurality of colors.

2. The method of claim 1, wherein the light source comprises a laser.

3. The method of claim 2, wherein the laser is a femtosecond laser.

4. The method of claim 3, wherein the femtosecond laser is a sub-80-fs laser.

5. The method of claim 1, wherein exciting the biological sample comprises:
exciting a first molecule in the biological sample via absorption of a first photon order by a single wavelength band of light; and
exciting a second molecule in the biological sample via absorption of a second photon order by the single wavelength band of light.

6. The method of claim 5, wherein the first molecule is a flavoprotein or a flavoprotein-like fluorophore and wherein the second molecule is NADH or NADPH.

7. The method of claim 5, wherein a first color of the plurality of colors comprises a color corresponding to a fluorescence signal of the first molecule and a second color of the plurality of colors comprises a color corresponding to a fluorescence signal of the second molecule.

8. The method of claim 5, wherein the plurality of colors further comprises at least one additional color detected from a harmonic process.

9. The method of claim 8, wherein the harmonic process is selected from the group consisting of SHG, THG, and first harmonic scattering.

10. The method of claim 5, wherein the plurality of colors further comprises at least one additional color detected from a fluorescence process.

11. The method of claim 10, wherein the fluorescence process is selected from the group consisting of four-photon excited fluorescence of ultraviolet fluorophores, three-photon excited fluorescence of green fluorescent proteins, two-photon excited fluorescence of red and near-infrared dyes, and one-photon excited fluorescence of near-infrared fluorophores.

12. The method of claim 11, wherein the ultraviolet fluorophore comprises tryptophan.

13. The method of claim 5, wherein the first molecule is excited via a 2-photon order process and the second molecule is excited via a 3-photon order process.

14. The method of claim 13, where the 2-photon order process is two-photon absorption and the 3-photon order process is three-photon absorption.

15. The method of claim 5, wherein the biological sample comprises a plurality of spatial components and wherein the detecting further comprises detecting light emitted by the first molecule located in a first one of the plurality of spatial components in a first color of the plurality of colors, and detecting light emitted by the second molecule located in a second one of the plurality of spatial components in a second color of the plurality of colors.

16. The method of claim 15, wherein the plurality of spatial components includes at least one of biological cells and extracellular media.

17. The method of claim 1, wherein the biological sample comprises flowing cells in a flow-cytometer.

18. The method of claim 1, wherein the biological sample comprises at least one of live cultured cells or in vivo tissue.

19. The method of claim 1, wherein the light source has a pulse repetition rate of 5-20 MHz.

20. The method of claim 1, wherein the light source is scanned over the biological sample at a fast-axis scanning speed of at least 35 μm/ms.
